(19) United States
(12) Patent Application Publication
(10) Pub. No.: US 2009/0264578 A1
(43) Pub. Date: Oct. 22, 2009

(54) Aggregation-preventive aqueous dispersion slurry coating material and process for producing the same

(75) Inventors: Masashi Minaki, Kyoto (JP); Yusuke Yamamoto, Kyoto (JP); Kazuyuki Kuwano, Aichi (JP); Kazuyuki Tachi, Aichi-Gun (JP); Kanji Mori, Aichi (JP)

Correspondence Address: EDWARDS ANGELL PALMER & DODGE LLP, P.O. BOX 55874, BOSTON, MA, 02205, US

(73) Assignees: Sanyo Chemical Industries, Ltd., Kyoto (JP); Toyota Jidosha Kabushiki Kaisha, Aichi, (JP)

(21) Appl. No.: 11/919,476

(22) PCT Filed: Apr. 28, 2006
(86) PCT No.: PCT/JP2006/308951

§ 371 Date: Jun. 16, 2009

(30) Foreign Application Priority Data
Jun. 14, 2005 (JP) 2005-173483
Apr. 28, 2006 (JP) 2005-133389

(51) Int. Cl. C08L 55/00; C08L 101/00; C08L 67/00

(52) U.S. Cl. 524/502; 524/500; 524/539

(57) ABSTRACT

Disclosed herein is an aqueous dispersion slurry coating material which has excellent storage stability and which can provide a coating film having excellent surface smoothness. The aqueous dispersion slurry coating material includes: an aqueous medium; and contained therein, resin particles (A) comprising a first resin (a); and resin particles (B) comprising a second resin (b), wherein the value of [volume-average particle diameter DA of resin particles (A)]/[volume-average particle diameter DB of resin particles (B)] is in the range of 0.003 to 0.3. It is preferred that the value of DA is in the range of 0.001 to 3 μm and that the value of DB is in the range of 0.3 to 10 μm. The resin (a) preferably has a Tg of 0 to 100° C., and the resin (b) preferably has a Tg of −50 to 50° C. The aqueous dispersion slurry coating material preferably further includes a surfactant and a curing agent. The resin (a) and the resin (b) are preferably of at least one kind selected from the group consisting of polyurethane resins, epoxy resins, vinyl resins, and polyester resins.

### TECHNICAL FIELD

The present invention relates to an aqueous dispersion slurry coating material and a method for producing the same. More specifically, the present invention relates to an aqueous dispersion slurry coating material which has excellent storage stability and which can provide a cured coating film having excellent surface smoothness by baking, and to a method for producing such an aqueous dispersion slurry coating material.

### BACKGROUND ART

In industrial fields, there is a demand for a low-volatile organic compound (hereinafter, abbreviated as “VOC”) coating material satisfying environmental standards. In addition, there is also a strong demand for a low-VOC coating material which can provide a thinner coating film and higher finished quality. Examples of such a low-VOC coating material include a powder coating material, an aqueous dispersion slurry coating material obtained by dispersing a powder coating material having a particle diameter of 1 to 10 μm in water, and an aqueous coating material.

In the case of a powder coating material, a coating film of higher finished quality can be obtained by using particles having a smaller particle size. However, by doing so, coating efficiency is significantly reduced, and therefore it is difficult to use particles having a particle diameter of 5 μm or less. In addition, such a powder coating material requires a coating machine specifically designed for powder coating materials. In the case of an aqueous coating material (e.g., an aqueous emulsion coating material) having a particle diameter of 0.3 μm or less, an existing coating machine for aqueous coating materials can be used, but there are problems that the finished quality of an obtained coating film is poor and that popping or the like occurs.

On the other hand, an aqueous dispersion slurry coating material has an advantage that it can be applied using an existing coating machine for aqueous coating materials. In addition, such an aqueous dispersion slurry coating material has a larger particle size as compared to an aqueous coating material (e.g., an aqueous emulsion coating material), and therefore popping is less likely to occur and an obtained coating film has excellent finished quality (see, for example, patent document 1). However, a conventional aqueous dispersion slurry coating material uses a resin composition having a high glass transition temperature to ensure its storage stability, and therefore an obtained coating film cured by baking is poor in smoothness. The smoothness of the coating film can be improved by using a resin composition having a lower glass transition temperature, but on the other hand, blocking or aggregation of resin particles contained in the coating material is more likely to occur, so that the storage stability of the coating material becomes poor (see, for example, patent document 2).

Patent document 1: Japanese Patent Application Laid-open No. H7-258601

Patent document 2: PCT International Application No. 2002-531608

### DISCLOSURE OF THE INVENTION

### Problems to be Solved by the Invention

It is therefore an object of the present invention to provide an aqueous dispersion slurry coating material which can prevent the occurrence of blocking or aggregation of resin particles contained therein to ensure excellent storage stability and which can provide a cured coating film having excellent surface smoothness by baking, and a method for producing such an aqueous dispersion slurry coating material.

### Means for Solving the Problems

The present invention is directed to an aqueous dispersion slurry coating material including: an aqueous medium (F); and contained therein, resin particles (A) comprising a first resin (a); and resin particles (B) comprising a second resin (b), wherein the value of [volume-average particle diameter of resin particles (A)]/[volume-average particle diameter of resin particles (B)] is in the range of 0.003 to 0.3, and a coating film obtained by applying and then baking the aqueous dispersion slurry coating material.

The present invention is also directed to a method for producing an aqueous dispersion slurry coating material (hereinafter, also referred to as a “production method according to the present invention”), comprising dispersing a resin (b) or a solution obtained by dissolving the resin (b) in a solvent (y) in an aqueous dispersion (G) containing a surfactant (D) and, dispersed in (G), resin particles (A) comprising a resin (a), and further removing the solvent (y) in a case where the resin (b) has been dissolved in the solvent (y), to form resin particles (B) comprising the resin (b) to thereby obtain an aqueous dispersion (X) wherein a value of [volume-average particle diameter of resin particles (A)]/[volume-average particle diameter of resin particles (B)] is in the range of 0.003 to 0.3, an aqueous dispersion slurry coating material obtained by the production method, and a coating film obtained by applying and then baking the aqueous dispersion slurry coating material.

### EFFECT OF THE INVENTION

The aqueous dispersion slurry coating material according to the present invention and a coating material composition obtained by the production method according to the present invention have the following effects, and are therefore very useful.

(1) The coating material is excellent in storage stability because blocking or aggregation of particles contained therein does not occur.

(2) A cured coating film obtained by baking the coating material is excellent in surface smoothness.

### BEST MODE FOR CARRYING OUT THE INVENTION

An aqueous dispersion slurry coating material according to the present invention includes in an aqueous medium (F), resin particles (A) comprising a first resin (a) (hereinafter, simply referred to as a “resin (a)”) and resin particles (B) comprising a second resin (b) (hereinafter, simply referred to as a “resin (b)”), wherein the value of [volume-average particle diameter D_{A} of resin particles (A)]/[volume-average particle diameter D_{B} of resin particles (B)] is in the range of 0.003 to 0.3. It is preferred that the volume-average particle diameter D_{A} of the resin particles (A) is in the range of 0.001 to 3 μm and that the volume-average particle diameter D_{B} of the resin particles (B) is in the range of 0.3 to 10 μm.

The volume-average particle diameter D_{A} of the resin particles (A) contained in the aqueous dispersion slurry coating material according to the present invention is preferably 0.001 μm or more and 3 μm or less, and is more preferably 0.002 μm or more, even more preferably 0.005 μm or more from the viewpoint of storage stability, and is more preferably 2 μm or less, even more preferably 1.5 μm or less from the viewpoint of the smoothness of an obtained coating film.

The volume-average particle diameter D_{A} of the resin particles (A) contained in the aqueous dispersion slurry coating material can be measured by particle size distribution analysis based on dynamic light scattering. An example of a particle size distribution analyzer includes DLS-7000 (manufactured by Otsuka Electronics Co., Ltd.). A measurement sample is prepared by, for example, centrifuging a dispersion of the resin particles (A) or the aqueous dispersion slurry coating material to obtain a supernatant and then diluting the supernatant with ion-exchanged water, and is measured. More specifically, a dispersion of the resin particles (A) or the aqueous dispersion slurry coating material is centrifuged using a high-speed refrigerated centrifuge GRX-220 (manufactured by TOMY Seiko Co., Ltd.) with a rotor No. 4II at 10,000 rpm for 5 minutes to obtain a supernatant, the supernatant is diluted 400-fold with ion-exchanged water to prepare a sample, and the sample is measured.

The volume-average particle diameter D_{A} of the resin particles (A) can be appropriately adjusted to a value suitable for achieving desired storage stability, as long as the particle size ratio is in the above range.

The volume-average particle diameter D_{B} of the resin particles (B) contained in the aqueous dispersion slurry coating material according to the present invention is preferably 0.3 μm or more and 10 μm or less, and is more preferably 0.7 μm or more, even more preferably 0.9 μm or more, particularly preferably 1 μm or more from the viewpoint of the strength of an obtained coating film, and is more preferably 8 μm or less, even more preferably 5 μm or less from the viewpoint of the smoothness of an obtained coating film.

The volume-average particle diameter of the resin particles (B) can be measured using a flow-type particle image analyzer (FPIA-2100 manufactured by Sysmex Corporation; a measurement sample is prepared by diluting the aqueous dispersion slurry coating material 400-fold with ion-exchanged water).

It is to be noted that in this specification, the particle diameter of resin particles mainly containing the resin (b), which is measured using the aqueous dispersion slurry coating material as a sample, is defined as a volume-average particle diameter D_{B} of the resin particles (B) irrespective of the form of the resin particles (B). The same goes for the following description.

The aqueous dispersion slurry coating material according to the present invention has a particle size ratio of [volume-average particle diameter D_{A} of resin particles (A)]/[volume-average particle diameter D_{B} of resin particles (B)] of 0.003 to 0.3. If the ratio of D_{A}/D_{B} is less than 0.003, the aqueous dispersion slurry coating material cannot show sufficient storage stability. On the other hand, if the ratio of D_{A}/D_{B} exceeds 0.3, the smoothness of an obtained coating film is poor. The ratio of D_{A}/D_{B} is preferably in the range of 0.004 to 0.2, more preferably in the range of 0.005 to 0.1.

As the resin (a) to be used in the present invention, any resin can be used as long as it can form an aqueous dispersion. The resin (a) may be either a thermoplastic resin or a thermosetting resin, and examples of the resin (a) include vinyl resins, polyurethane resins, epoxy resins, polyester resins, polyamide resins, polyimide resins, silicon-based resins, phenol resins, melamine resins, urea resins, aniline resins, ionomer resins, and polycarbonate resins. These resins may be used in combination of two or more of them. Among these resins, vinyl resins, polyurethane resins, epoxy resins, polyester resins, and mixtures of two or more of them are preferred from the viewpoint of easily obtaining an aqueous dispersion of fine spherical resin particles.

The resin (a) preferably has a reactive functional group.

Examples of the reactive functional group contained in the resin (a) include a carboxyl group, an epoxy group, a hydroxyl group, a hydrolyzable silyl group, a blocked carboxyl group, a blocked amino group, and a blocked isocyanate group. Among them, from the viewpoint of storage stability during production and storage, a carboxyl group, an epoxy group, a hydroxyl group, a blocked carboxyl group, a blocked amino group, and a blocked isocyanate group are preferred, and an epoxy group, a hydroxyl group, and a blocked isocyanate group are more preferred.

Examples of a blocking agent for the blocked carboxyl group include ammonia, tertiary alcohols having 4 to 19 carbon atoms (e.g., t-butanol, triethylcarbinol, tributylcarbinol, and triphenylcarbinol), and vinyl compounds having 4 to 18 carbon atoms (e.g., 2-methylpropene and 2-methylhexene). Among them, from the viewpoint of storage stability and ease of elimination by heat treatment, tertiary alcohols are preferred, and t-butanol and triethylcarbinol are more preferred.

Examples of a blocking agent for the blocked amino group include ketones having 3 to 15 carbon atoms, such as aliphatic ketones (e.g., acetone and methyl isobutyl ketone), aromatic ketones (e.g., benzophenon), and alicyclic ketones (e.g., dicyclohexyl ketone). Among them, from the viewpoint of storage stability and ease of elimination by heat treatment, aliphatic ketones are preferred, and methyl isobutyl ketone is more preferred.

Examples of a blocking agent for the blocked isocyanate group include oximes having 3 to 10 carbon atoms (e.g., acetoxime and methyl ethyl ketoxime), alcohols (monohydric alcohols having 1 to 18 carbon atom(s), such as methyl alcohol, isopropyl alcohol, and t-butyl alcohol), phenol compounds (monohydric phenols having 6 to 20 carbon atoms, such as monocyclic phenols (e.g., phenol and nitro phenol) and polycyclic phenols (e.g., 1-naphthol)), and lactams having 4 to 15 carbon atoms (e.g., γ-butyrolactam, ε-caprolactam, and γ-valerolactam). Among them, from the viewpoint of storage stability and ease of elimination by heat treatment, oximes and lactams are preferred, and acetoxime and ε-caprolactam are more preferred.

From the viewpoint of the strength of an obtained coating film, the number of reactive functional groups in one molecule of the resin (a) is preferably one or more, more preferably 2 or more. It is to be noted that the upper limit of the number of reactive functional groups in one molecule of the resin (a) cannot be determined because there is a case where the resin (a) is a cross-linked resin.

Examples of a method for forming a resin (a) having such a reactive functional group introduced thereinto include (co)polymerization of a monomer(s) having the reactive functional group, (co)polymerization using a polymerization initiator having the reactive functional group, and introduction of the reactive functional group by modification of a resin obtained by (co)polymerization. Among these methods, from the viewpoint of ease of introducing the reactive functional group, (co)polymerization of a monomer(s) having the reactive functional group is preferred.

Examples of the vinyl resins include homopolymers of a vinyl monomer and copolymers of two or more vinyl monomers. Examples of the vinyl monomers include the following (1) to (10).

(1) vinyl hydrocarbons:

(1-1) aliphatic vinyl hydrocarbons such as alkenes (e.g., ethylene, propylene, butene, isobutylene, pentene, heptene, diisobutylene, octene, dodecene, octadecene, and other α-olefins) and alkadienes (e.g., butadiene, isoprene, 1,4-pentadiene, 1,6-hexadiene, and 1,7-octadiene);

(1-2) alicyclic vinyl hydrocarbons such as monocycloalkenes, dicycloalkenes, monocycloalkadienes, and dicycloalkadienes (e.g., cyclohexene, (di)cyclopentadiene, vinylcyclohexene, and ethylidenebicycloheptene) and terpenes (e.g., pinene, limonene, and indene); and

(1-3) aromatic vinyl hydrocarbons such as styrene and hydrocarbyl (alkyl, cycloalkyl, aralkyl, and/or alkenyl)-substituted styrene (e.g., α-methyl styrene, vinyl toluene, 2,4-dimethyl styrene, ethyl styrene, isopropyl styrene, butyl styrene, phenyl styrene, cyclohexyl styrene, benzyl styrene, crotyl benzene, divinyl benzene, divinyl toluene, divinyl xylene, and trivinyl benzene) and vinyl naphthalene.

(2) Carboxyl group-containing vinyl monomers and salts thereof: unsaturated monocarboxylic and dicarboxylic acids having 3 to 30 carbon atoms, anhydrides thereof, and monoalkyl (1 to 24 carbon atom(s)) esters thereof (e.g., (meth)acrylic acid, maleic acid (anhydride), maleic acid monoalkyl esters, fumaric acid, fumaric acid monoalkyl esters, crotonic acid, itaconic acid, itaconic acid monoalkyl esters, itaconic acid glycol monoesters, citraconic acid, citraconic acid monoalkyl esters, and cinnamic acid) and salts thereof.

(3) Sulfone group-containing vinyl monomers, vinyl monoesters of sulfuric acid, and salts thereof: alkenesulfonic acids having 2 to 14 carbon atoms (e.g., vinylsulfonic acid, (meth)allylsulfonic acid, methylvinylsulfonic acid, and styrenesulfonic acid); alkyl derivatives thereof having 2 to 24 carbon atoms (e.g., α-methylstyrenesulfonic acid); sulfo(hydroxyl)alkyl-(meth)acrylates and -(meth)acrylamides (e.g., sulfopropyl(meth)acrylate, 2-hydroxy-3-(meth)acryloxypropylsulfonic acid, 2-(meth)acryloylamino-2,2-dimethylethanesulfonic acid, 2-(meth)acryloyloxyethanesulfonic acid, 3-(meth)acryloyloxy-2-hydroxypropanesulfonic acid, 2-(meth)acrylamide-2-methylpropanesulfonic acid, 3-(meth)acrylamide-2-hydroxypropanesulfonic acid, alkyl (3 to 18 carbon atoms) allylsulfosuccinic acid, poly(n=2 to 30) oxyalkylene(e.g., ethylene, propylene, butylene: homo, random, or block) mono(meth)acrylate sulfates (e.g., poly(n=5 to 15) oxypropylene monomethacrylate sulfates), polyoxyethylene polycyclic phenyl ether sulfate, and sulfuric acid ester or sulfonic acid group-containing monomers; and salts thereof.

(4) Phosphoric group-containing vinyl monomers and salts thereof: (meth)acryloyloxyalkyl(C1 to C24) phosphoric acid monoesters (e.g., 2-hydroxyethyl(meth)acryloyl phosphate and phenyl-2-acryloyloxyethyl phosphate); and (meth)acryloyloxyalkyl (1 to 24 carbon atom(s)) phosphonic acids (e.g., 2-acryloyloxyethyl phosphonic acid); and salts thereof.

It is to be noted that examples of the salts of the monomers mentioned in the above (2) to (4) include alkali metal salts (e.g., sodium salts and potassium salts), alkaline-earth metal salts (e.g., calcium salts and magnesium salts), ammonium salts, amine salts, and quaternary ammonium salts.

(5) Hydroxyl group-containing vinyl monomers: hydroxystyrene, N-methylol(meth)acrylamide, hydroxyethyl(meth)acrylate, hydroxypropyl(meth)acrylate, polyethylene glycol mono(meth)acrylate, (meth)allyl alcohol, crotyl alcohol, isocrotyl alcohol, 1-butene-3-ol, 2-butene-1-ol, 2-butene-1,4-diol, propargyl alcohol, 2-hydroxyethyl propenyl ether, and sucrose allyl ether.

(6) Nitrogen-containing vinyl monomers: (6-1) amino group-containing vinyl monomers such as aminoethyl (meth)acrylate, dimethylaminoethyl (meth)acrylate, diethylaminoethyl (meth)acrylate, t-butylaminoethyl methacrylate, N-aminoethyl (meth) acrylamide, (meth) allylamine, morpholinoethyl (meth)acrylate, 4-vinylpyridine, 2-vinylpyridine, crotylamine, N,N-dimethylaminostyrene, methyl α-acetoaminoacrylate, vinylimidazole, N-vinylpyrrole, N-vinylthiopyrrolidone, N-arylphenylenediamine, aminocarbazole, aminothiazole, aminoindole, aminopyrrole, aminoimidazole, aminomercaptothiazole, and salts thereof; (6-2) amide group-containing vinyl monomers such as (meth)acrylamide, N-methyl(meth)acrylamide, N-butylacrylamide, diacetoneacrylamide, N-methylol(meth)acrylamide, N,N′-methylene-bis(meth)acrylamide, cinnamic acid amide, N,N-dimethylacrylamide, N,N-dibenzylacrylamide, methacrylformamide, N-methyl-N-vinylacetamide, and N-vinylpyrrolidone; (6-3) nitrile group-containing vinyl monomers such as (meth)acrylonitrile, cyanostyrene, and cyanoacrylate; (6-4) quaternary ammonium cation group-containing vinyl monomers such as quaternization products of tertiary amine group-containing vinyl monomers such as dimethylaminoethyl (meth)acrylate, diethylaminoethyl (meth)acrylate, dimethylaminoethyl (meth)acrylamide, diethylaminoethyl (meth)acrylamide, and diallylamine (as quaternized using a quaternizing agent such as methyl chloride, dimethylsulfuric acid, benzyl chloride, or dimethyl carbonate); and (6-5) nitro group-containing vinyl monomers such as nitrostyrene.

(7) Oxirane or oxolane group-containing vinyl monomers: e.g., glycidyl (meth)acrylate and tetrahydrofurfuryl (meth)acrylate.

(8) Halogen element-containing vinyl monomers: e.g., vinyl chloride, vinyl bromide, vinylidene chloride, allyl chloride, chlorostyrene, bromostyrene, dichlorostyrene, chloromethylstyrene, tetrafluorostyrene, and chloroprene.

(9) Vinyl esters, vinyl(thio)ethers, vinyl ketones, and vinyl sulfones: (9-1) vinyl esters such as vinyl acetate, vinyl butyrate, vinyl propionate, vinyl butyrate, diallyl phthalate, diallyl adipate, isopropenyl acetate, vinyl methacrylate, methyl 4-vinyl benzoate, cyclohexyl methacrylate, benzyl methacrylate, phenyl(meth)acrylate, vinylmethoxy acetate, vinyl benzoate, ethyl α-ethoxyacrylate, alkyl (meth)acrylates having an alkyl group containing 1 to 50 carbon atom(s) (e.g., methyl (meth)acrylate, ethyl (meth)acrylate, propyl (meth)acrylate, butyl (meth)acrylate, 2-ethylhexyl (meth)acrylate, dodecyl (meth)acrylate, hexadecyl (meth)acrylate, heptadecyl (meth)acrylate, and eicosyl (meth)acrylate), dialkyl fumarates (each of the two alkyl groups is a liner, branched, or alicyclic group having 2 to 8 carbon atoms), dialkylmaleates (each of the two alkyl groups is a liner, branched, or alicyclic group having 2 to 8 carbon atoms), poly(meth)allyloxyalkanes (e.g., diallyloxyethane, triallyloxyethane, tetraallyloxyethane, tetraallyloxypropane, tetraallyloxybutane, and tetramethallyloxyethane), polyalkylene glycol chain-containing vinyl monomers [e.g., polyethyleneglycol (molecular weight: 300) mono(meth)acrylate, polypropylene glycol (molecular weight: 500) monoacrylate, methyl alcohol-ethylene oxide (10 mol) adduct (meth)acrylates, and lauryl alcohol-ethylene oxide (30 mol) adduct (meth)acrylates], and poly(meth)acrylates (e.g., poly(meth)acrylates of polyhydric alcohols such as ethylene glycol di(meth)acrylate, propylene glycol di(meth)acrylate, neopentyl glycol di(meth)acrylate, trimethylolpropane tri(meth)acrylate, and polyethylene glycol di(meth)acrylate); (9-2) vinyl (thio) ethers such as vinyl methyl ether, vinyl ethyl ether, vinyl propyl ether, vinyl butyl ether, vinyl 2-ethylhexyl ether, vinyl phenyl ether, vinyl 2-methoxyethyl ether, methoxybutadiene, vinyl 2-butoxyethyl ether, 3,4-dihydro-1,2-pyran, 2-butoxy-2′-vinyloxy diethyl ether, vinyl 2-ethylmercaptoethyl ether, acetoxystyrene, and phenoxystyrene; and (9-3) vinyl ketones such as vinyl methyl ketone, vinyl ethyl ketone, and vinyl phenyl ketone and vinyl sulfones such as divinyl sulfide, p-vinyldiphenyl sulfide, vinylethyl sulfide, vinylethyl sulfone, divinyl sulfone, and divinyl sulfoxide.

(10) Other vinyl monomers: e.g., isocyanatoethyl (meth)acrylate and m-isopropenyl-α,α-dimethylbenzyl isocyanate.

The copolymers of vinyl monomers include polymers obtained by binary or higher copolymerization of any two or more of the monomers mentioned in the above (1) to (10) at any ratio, and examples of such polymers include styrene-(meth)acrylic acid ester copolymer, styrene-butadiene copolymer, (meth)acrylic acid-acrylic acid ester copolymer, styrene-acrylonitrile copolymer, styrene-maleic anhydride copolymer, styrene-(meth)acrylic acid copolymer, styrene-(meth)acrylic acid-divinylbenzene copolymer, and styrene-styrenesulfonic acid-(meth)acrylic acid ester copolymer.

The resin (a) is preferably nonionic. In this specification, a nonionic resin refers to a resin not having an ionic functional group.

The resin (a) needs to be formed into resin particles (A) in the aqueous medium (F), and therefore it is necessary that the resin (a) should not completely dissolve in at least the aqueous medium (F). Therefore, in a case where the vinyl resin is a copolymer, the ratio between a hydrophobic monomer and a hydrophilic monomer constituting the vinyl resin depends on the kinds of monomers selected, but the ratio of the hydrophobic monomer is generally preferably 10% or higher, more preferably 30% or higher. If the ratio of the hydrophobic monomer is 10% or less, the vinyl resin becomes water-soluble, so that the storage stability of the aqueous dispersion slurry coating material according to the present invention is deteriorated. It is to be noted that the hydrophilic monomer refers to a monomer having a hydrophilic group such as a carboxyl group, a hydroxyl group, an amino group, a sulfone group, a phosphoric group, or a thiol group, and a salt thereof.

Examples of the polyester resins include polycondensation products of a polyol and a polycarboxylic acid, an acid anhydride thereof, or a lower alkyl ester thereof. Examples of the polyol include diols (11) and polyols (12) having three or more hydroxyl groups. Examples of the polycarboxylic acid, acid anhydride thereof, and lower alkyl ester thereof include dicarboxylic acids (13), polycarboxylic acids (14) having three or more carboxyl groups, acid anhydrides thereof, and lower alkyl esters thereof. The ratio between the polyol and the polycarboxylic acid, expressed in an equivalent ratio ([OH]/[COOH]) of hydroxyl groups [OH] to carboxyl groups [COOH], is generally 2/1 to 1/1, preferably 1.5/1 to 1/1, more preferably 1.3/1 to 1.02/1.

Examples of the diol (11) include: alkyleneglycols (e.g., ethylene glycol, 1,2-propylene glycol, 1,3-propylene glycol, 1,4-butanediol, 1,6-hexanediol, octanediol, decanediol, dodecanediol, tetradecanediol, neopentyl glycol, and 2,2-diethyl-1,3-propanediol); alkylene ether glycols (e.g., diethylene glycol, triethylene glycol, dipropylene glycol, polyethylene glycol, polypropylene glycol, and polytetramethylene ether glycol); alicyclic diols (e.g., 1,4-cyclohexanedimethanol and hydrogenated bisphenol A); bisphenols (e.g., bisphenol A, bisphenol F, and bisphenol S); alkylene oxide (e.g., ethylene oxide, propylene oxide, or butylene oxide) adducts of the alicyclic diols; alkylene oxide (e.g., ethylene oxide, propylene oxide, or butylene oxide) adducts of the bisphenols; and other diols such as polylactone diols (e.g., poly ε-caprolactone diol) and polybutadiene diol. Among these diols, alkylene glycols having 2 to 12 carbon atoms and alkylene oxide adducts of bisphenols are preferred, and alkylene oxide adducts of bisphenols are particularly preferably used alone or in combination with alkylene glycols having 2 to 12 carbon atoms.

Examples of the polyols (12) having three or more hydroxyl groups include: tri- to octa- or higher polyhydric aliphatic alcohols (e.g., glycerol, trimethylolethane, trimethylolpropane, pentaerythritol, and sorbitol); trisphenols (e.g., trisphenol PA); novolac resins (e.g., phenol novolac and cresol novolac); alkylene oxide adducts of the trisphenols; alkylene oxide adducts of the novolac resins; and acrylic polyols (e.g., copolymers of hydroxyethyl (meth)acrylate and one or more other vinyl monomers). Among these polyols, tri- to octa- or higher polyhydric aliphatic alcohols and alkylene oxide adducts of novolac resins are preferred, and alkylene oxide adducts of novolac resins are particularly preferred.

Examples of the dicarboxylic acids (13) include: alkylene dicarboxylic acids (e.g., succinic acid, adipic acid, sebacic acid, dodecenyl succinic acid, azelaic acid, dodecanedicarboxylic acid, and octadecanedicarboxylic acid); alkenylenedicarboxylic acids (e.g., maleic acid and fumaric acid); branched alkylenedicarboxylic acids having 8 or more carbon atoms [e.g., dimer acid, alkenylsuccinic acids (e.g., dodecenylsuccinic acid, pentadecenylsuccinic acid, and octadecenylsuccinic acid), and alkylsuccinic acids (e.g., decylsuccinic acid, dodecylsuccinic acid, and octadecylsuccinic acid)]; and aromatic dicarboxylic acids (e.g., phthalic acid, isophthalic acid, terephthalic acid, and naphthalenedicarboxylic acid). Among these dicarboxylic acids, alkenylenedicarblxylic acids having 4 to 20 carbon atoms and aromatic dicarboxylic acids having 8 to 20 carbon atoms are preferred.

Examples of the polycarboxylic acids (14) having three of more carboxyl groups include aromatic polycarboxylic acids having 9 to 20 carbon atoms (e.g., trimellitic acid and pyromellitic acid). It is to be noted that as the dicarboxylic acids (13) or the polycarboxylic acids (14) having three or more carboxyl groups, acid anhydrides or lower alkyl esters (e.g., methyl ester, ethyl ester, and isopropyl ester) of the dicarboxylic acids or the polycarboxylic acids mentioned above can also be used.

An example of a method for introducing a reactive functional group (e.g., a carboxyl group or a hydroxyl group) into the polyester resin includes a method in which an equivalent ratio of COOH/OH for reaction between a carboxyl group-containing component and a hydroxyl group-containing component is controlled.

In a case where a carboxyl group is introduced into the polyester resin, the equivalent ratio is preferably more than 1 but 10 or less, more preferably 1.1 to 3 from the viewpoint of the curing properties of an obtained coating film and the pigment dispersibility of the resin. In a case where a hydroxyl group is introduced into the polyester resin, the equivalent ratio is preferably 0.2 or more but less than 1, more preferably 0.7 to 0.9 from the viewpoint of the weatherability of the cured resin and the pigment dispersibility of the resin.

Examples of a method for producing the polyester resin include polyester polymerization methods conventionally used such as dehydration polycondensation reaction between a polycarboxylic acid and a polyol and ester exchange reaction between an ester-forming derivative of a polycarboxylic acid and a polyol.

Examples of the polyurethane resins include polyaddition products of a polyisocyanate (15) and an active hydrogen group-containing compound [e.g., water, a polyol (e.g., the above-mentioned diol (11) and polyol (12) having three or more hydroxyl groups), the dicarboxylic acid (13), the polycarboxylic acid (14) having three or more carboxyl groups, a polyamine (16), or a polythiol (17)].

Examples of the polyisocyanate (15) include aromatic polyisocyanates having 6 to 20 carbon atoms (exclusive of the carbon atom in the NCO group; the same goes for the following), aliphatic polyisocyanates having 2 to 18 carbon atoms, alicyclic polyisocyanates having 4 to 15 carbon atoms, araliphatic polyisocyanates having 8 to 15 carbon atoms, modification products of these polyisocyanates (e.g., modified polyisocyanates containing a urethane group, a carbodiimide group, an allophanate group, a urea group, a biuret group, a urethodione group, a urethoimine group, an isocyanurate group, or an oxazolidone group), and mixtures of two or more of them. Specific examples of the aromatic polyisocyanates include 1,3- and/or 1,4-phenylenediisocyanate, 2,4- and/or 2,6-tolylenediisocyanate (TDI), crude TDI, 2,4′- and/or 4,4′-diphenylmethanediisocyanate (MDI), crude MDI {a phosgenation product of crude diaminophenylmethane [a condensation product of formaldehyde with an aromatic amine (aniline) or a mixture thereof; a mixture of diaminodiphenylmethane and a small amount (e.g., 5 to 20 wt %) of a tri- or higher-functional polyamine]: polyallylpolyisocyanate (PAPI)}, 1,5-naphthylene diisocyanate, 4,4′,4″-triphenylmethane triisocyanate, and m- and p-isocyanatophenylsulfonyl isocyanate. Specific examples of the aliphatic polyisocyanates include ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethyl caproate, bis(2-isocyanatoethyl) fumarate, bis(2-isocyanatoethyl) carbonate, and 2-isocyanatoethyl-2,6-diisocyanatohexanoate. Specific examples of the alicyclic polyisocyanates include isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, and 2,5- and/or 2,6-norbornane diisocyanate. Specific examples of the araliphatic polyisocyanates include m- and/or p-xylylene diisocyanate (XDI) and α, α, α′, α″-tetramethylxylylenediisocyanate (TMXDI).

Examples of the modification products of polyisocyanates include modified polyisocyanates containing a urethane group, a carbodiimide group, an allophanate group, a urea group, a biuret group, a urethodione group, a urethoimine group, an isocyanurate group, or an oxazolidone group, and specific examples thereof include modification products of polyisocyanate such as modified MDIs (e.g., urethane-modified MDI, carbodiimide-modified MDI, and trihydrocarbyl phosphate-modified MDI) and urethane-modified TDI; and mixtures of two or more of them [e.g., a mixture of modified MDI and urethane-modified TDI (isocyanate-containing prepolymer)]. Among them, aromatic polyisocyanates having 6 to 15 carbon atoms, aliphatic polyisocyanates having 4 to 12 carbon atoms, and alicyclic polyisocyanates having 4 to 15 carbon atoms are preferred, and TDI, MDI, HDI, hydrogenated MDI, and IPDI are particularly preferred.

Examples of the polyamine (16) include aliphatic polyamines (C2 to C18) such as (1) aliphatic polyamines [e.g., C2 to C6 alkylenediamines (e.g., ethylenediamine, propylenediamine, trimethylenediamine, tetramethylenediamine, and hexamethylenediamine) and polyalkylene (C2 to C6) polyamines (e.g., diethylenetriamine, iminobispropylamine, bis(hexamethylene)triamine, triethylenetetramine, tetraethylenepentamine, and pentaethylenehexamine)], (2) alkyl (C1 to C4)- or hydroxyalkyl (C2 to C4)-substitution products of these polyamines (e.g., dialkyl (C1 to C3) aminopropylamine, trimethylhexamethylenediamine, aminoethylethanolamine, 2,5-dimethyl-2,5-hexamethylenediamine, and methyliminobispropylamine), (3) alicyclic or heterocycle-containing aliphatic polyamines (e.g., 3,9-bis(3-aminopropyl)-2,4,8,10-tetraoxaspiro[5,5]undecane), (4) aromatic ring-containing aliphatic amines (C8 to C15) (e.g., xylylenediamine and tetrachloro-p-xylylenediamine), alicyclic polyamines (C4 to C15) (e.g., 1,3-diaminocyclohexane, isophoronediamine, menthenediamine, and 4,4′-methylenedicyclohexanediamine (hydrogenated methylenedianiline)), heterocyclic polyamines (C4 to C15) (e.g., piperazine, N-aminoethylpiperazine, 1,4-diaminoethylpiperazine, and 1,4-bis(2-amino-2-methylpropyl)piperazine), and aromatic polyamines (C6 to C20), (5) non-substituted aromatic polyamines (e.g., 1,2-, 1,3-, and 1,4-phenylenediamine, 2,4′-, and 4,4′-diphenylmethanediamine, crude diphenylmethanediamine (polyphenylpolymethylenepolyamine), diaminodiphenylsulfone, benzidine, thiodianiline, bis(3,4-diaminophenyl)sulfone, 2,6-diaminopyridine, m-aminobenzylamine, triphenylmethane-4,4′,4′-triamine, and naphthylenediamine), nuclear-substituted alkyl group (e.g., a C1 to C4 alkyl group such as methyl, ethyl, n- or i-propyl, or butyl)-containing aromatic polyamines (e.g., 2,4- and 2,6-tolylenediamine, crude tolylenediamine, diethyltolylenediamine, 4,4′-diamino-3,3′-dimethyldiphenylmethane, 4,4′-bis(o-toluidine), dianisidine, diaminoditolylsulfone, 1,3-dimethyl-2,4-diaminobenzene, 1,3-diethyl-2,4-diaminobenzene, 1,3-dimethyl-2,6-diaminobenzene, 1,4-diethyl-2,5-diaminobenzene, 1,4-diisopropyl-2,5-diaminobenzene, 1,4-dibutyl-2,5-diaminobenzene, 2,4-diaminomesitylene, 1,3,5-triethyl-2,4-diaminobenzene, 1,3,5-triisopropyl-2,4-diaminobenzene, 1-methyl-3,5-diethyl-2,4-diaminobenzene, 1-methyl-3,5-diethyl-2,6-diaminobenzene, 2,3-dimethyl-1,4-diaminonaphthalene, 2,6-dimethyl-1,5-diaminonaphthalene, 2,6-diisopropyl-1,5-diaminonaphthalene, 2,6-dibutyl-1,5-diaminonaphthalene, 3,3′,5,5′-tetramethylbenzidine, 3,3′,5,5′-tetraisopropylbenzidine, 3,3′,5,5′-tetramethyl-4,4′-diaminodiphenylmethane, 3,3′,5,5′-tetraethyl-4,4′-diaminodiphenylmethane, 3,3′,5,5′-tetraisopropyl-4,4′-diaminodiphenylmethane, 3,3′,5,5′-tetrabutyl-4,4′-diaminodiphenylmethane, 3,5-diethyl-3′-methyl-2′,4-diaminodiphenylmethane, 3,5-diisopropyl-3′-methyl-2′7,4-diaminodiphenylmethane, 3,3′-diethyl-2,2′-diaminodiphenylmethane, 4,4′-diamino-3,3′-dimethyldiphenylmethane, 3,3′,5,5′-tetraethyl-4,4′-diaminobenzophenone, 3,3′,5,5′-tetraisopropyl-4,4′-diaminobenzophenone, 3,3′,5,5′-tetraethyl-4,4′-diaminodiphenyl ether, and 3,3′,5,5′-tetraisopropyl-4,4′-diaminodiphenylsulfone) and mixtures of their isomers in various ratios, (6) nuclear-substituted electron-withdrawing group (e.g., a halogen such as Cl, Br, I, or F; an alkoxy group such as methoxy or ethoxy; or a nitro group)-containing aromatic polyamines (e.g., methylenebis-o-chloroaniline, 4-chloro-o-phenylenediamine, 2-chloro-1,4-phenylenediamine, 3-amino-4-chloroaniline, 4-bromo-1,3-phenylenediamine, 2,5-dichloro-1,4-phenylenediamine, 5-nitro-1,3-phenylenediamine, 3-dimethoxy-4-aminoaniline, 4,4′-diamino-3,3′-dimethyl-5,5′-dibromo-diphenylmethane, 3,3′-dichlorobenzidine, 3,3′-dimethoxybenzidine, bis(4-amino-3-chlorophenyl)oxide, bis(4-amino-2-chlorophenyl)propane, bis(4-amino-2-chlorophenyl)sulfone, bis(4-amino-3-methoxyphenyl)decane, bis(4-aminophenyl)sulfide, bis(4-aminophenyl)telluride, bis(4-aminophenyl)selenide, bis(4-amino-3-methoxyphenyl)disulfide, 4,4′-methylenebis(2-iodoaniline), 4,4′-methylenebis(2-bromoaniline), 4,4′-methylenebis(2-fluoroaniline), and 4-aminophenyl-2-chloroaniline), and (7) secondary amino group-containing aromatic polyamines [obtained by replacing some or all of —NH₂ in the aromatic polyamines mentioned in the above (4) and (5) with —NH—R′ (R′ is a lower alkyl group such as methyl or ethyl)] (e.g., 4,4′-di(methylamino)diphenylmethane and 1-methyl-2-methylamino-4-aminobenzene), polyamide polyamines [e.g., low molecular weight-polyamide polyamines obtained by condensation of a dicarboxylic acid (e.g., dimer acid) with an excess amount (2 or more moles per mol of acid) of polyamines (e.g., the alkylenediamine or polyalkylenepolyamine mentioned above)], and polyether polyamines [e.g., hydrides of cyanoethylation products of polyether polyols (e.g., polyalkylene glycols)].

Examples of the polythiol (17) include ethylenedithiol, 1,4-butanedithiol, and 1,6-hexanedithiol.

Examples of the epoxy resins include ring-opening polymerization products of a polyepoxide (18), polyaddition products of the polyepoxide (18) with an active hydrogen group-containing compound {e.g., water, a polyol [e.g., the above-mentioned diol (11) or polyol (12) having three or more hydroxyl groups], the dicarboxylic acid (13), the polycarboxylic acid (14) having three or more carboxyl groups, the polyamine (16), or the polythiol (17)}, and curing reaction products of the polyepoxide (18) with an acid anhydride of the dicarboxylic acid (13) or the polycarboxylic acid (14) having three or more carboxyl groups.

The polyepoxide (18) to be used in the present invention is not particularly limited as long as it has two or more epoxy groups in a molecule. From the viewpoint of mechanical properties of an obtained curing reaction product, the polyepoxide (18) preferably has 2 to 6 epoxy groups in a molecule. The epoxy equivalent (i.e., a molecular weight per epoxy group) of the polyepoxide (18) is generally 65 to 1,000, preferably 90 to 500. If the epoxy equivalent of the polyepoxide (18) exceeds 1,000, the cross-linked structure of an obtained curing reaction product becomes loose, so that the physical properties of the curing reaction product, such as water resistance, chemical resistance, and mechanical strength are deteriorated. On the other hand, the polyepoxide (18) whose epoxy equivalent is less than 65 is difficult to be synthesized.

Examples of the polyepoxide (18) include an aromatic polyepoxy compound, a heterocyclic polyepoxy compound, an alicyclic polyepoxy compound, and an aliphatic polyepoxy compound. Examples of the aromatic polyepoxy compound include glycidyl ethers and glycidyl esters of polyhydric phenols, glycidyl aromatic polyamines, and glycidylation products of aminophenols. Examples of the glycidyl ethers of polyhydric phenols include bisphenol F diglycidyl ether, bisphenol A diglycidyl ether, bisphenol B diglycidyl ether, bisphenol AD diglycidyl ether, bisphenol S diglycidyl ether, halogenated bisphenol A diglycidyl ether, tetrachlorobisphenol A diglycidyl ether, catechin diglycidyl ether, resorcinol diglycidyl ether, hydroquinone diglycidyl ether, pyrogallol triglycidyl ether, 1,5-dihydroxynaphthalene diglycidyl ether, dihydroxybiphenyl diglycidyl ether, octachloro-4,4′-dihydroxybiphenyl diglycidyl ether, tetramethylbiphenyl diglycidyl ether, dihydroxynaphthylcresol triglycidyl ether, tris (hydroxyphenyl)methane triglycidyl ether, dinaphthyltriol triglycidyl ether, tetrakis(4-hydroxyphenyl)ethane tetraglycidyl ether, p-glycidylphenyldimethyltolyl bisphenol A glycidyl ether, trismethyl-tert-butyl-butylhydroxymethane triglycidyl ether, 9,9′-bis(4-hydroxyphenyl)fluorene diglycidyl ether, 4,4′-oxybis(1,4-phenylethyl)tetracresol glycidyl ether, 4,4′-oxybis(1,4-phenylethyl)phenyl glycidyl ether, bis(dihydroxynaphthalene) tetraglycidyl ether, glycidyl ethers of phenol or cresol novolac resins, glycidyl ethers of limonene phenol novolac resins, diglycidyl ethers obtained by reaction between 2 moles of bisohenol A and 3 moles of epichlorohydrin, and polyglycidyl ethers of polyphenols obtained by condensation reaction between phenol and glyoxal, glutaraldehyde, or formaldehyde, and polyglycidyl ethers of polyphenols obtained by condensation reaction between resorcin and acetone. Examples of the glycidyl esters of polyphenols include phthalic acid diglydicyl esters, isophthalic acid diglycidyl esters, and terephthalic acid diglycidyl esters. Examples of the glycidyl aromatic polyamines include N,N-diglycidylaniline, N,N,N′,N′-tetraglycidylxylylenediamine, and N,N,N′,N′-tetraglycidyldiphenylmethanediamine. It is to be noted that in the present invention, the above-mentioned aromatic polyepoxy compound also includes p-aminophenol triglycidyl ether, a diglycidylurethane compound obtained by addition reaction between tolylene diisocyanate or diphenylmethane diisocyanate and glycidol, a glycidyl group-containing polyurethane (pre)polymer obtained by reacting the above two reactants with a polyol, and diglycidyl ethers of alkylene oxide (e.g., ethylene oxide or propylene oxide) adducts of bisphenol A. An example of the heterocyclic polyepoxy compound includes trisglycidylmelamine. Examples of the alicyclic polyepoxy compound include vinylcyclohexene dioxide, limonene dioxide, dicyclopentadiene dioxide, bis(2,3-epoxycyclopentyl)ether, ethylene glycol bisepoxydicyclopentyl ether, 3,4-epoxy-6-methylcyclohexylmethyl-3′,4′-epoxy-6′-methylcyc lohexane carboxylate, bis(3,4-epoxy-6-methylcyclohexylmethyl)adipate, bis(3,4-epoxy-6-methylcyclohexylmethyl)butylamine, and dimer acid diglycidyl ester. The alicyclic polyepoxy compound also includes nuclear hydrogenation products of the aromatic polyepoxide compounds mentioned above. Examples of the aliphatic polyepoxy compound include polyglycidyl ethers of polyhydric aliphatic alcohols, polyglycidyl esters of polyvalent fatty acids, and glycidyl aliphatic amines. Examples of the polyglycidyl ethers of polyhydric aliphatic alcohols include ethylene glycol diglycidyl ether, propylene glycol diglydicyl ether, tetramethylene glycol diglycidyl ether, 1,6-hexanediol diglycidyl ether, polyethylene glycol diglycidyl ether, polyprolylene glycol diglycidyl ether, polytetramethylene glycol diglycidyl ether, neopentyl glycol diglycidyl ether, trimethylolpropane polyglycidyl ether, glycerol polyglycidyl ether, pentaerithritol polyglycidyl ether, sorbitol polyglycidyl ether, and polyglycerol polyglycidyl ether. Examples of the polyglycidyl esters of polyvalent fatty acids include diglycidyl oxalate, diglycidyl maleate, diglycidyl succinate, diglycidyl glutarate, diglycidyl adipate, and diglycidyl pimelate. An example of the glycidyl aliphatic amines includes N,N,N′,N′-tetraglycidyl hexamethylenediamine. In the present invention, the aliphatic polyepoxy compound also includes (co)polymers of diglycidyl ethers and glycidyl (meth)acrylates. Among these compounds, the aliphatic polyepoxy compounds and the aromatic polyepoxy compounds are preferred. In the present invention, these polyepoxides may be used in combination of two or more of them.

From the viewpoint of storage stability, the glass transition temperature (hereinafter, simply referred to as “Tg”) of the resin (a) is preferably 0 to 100° C., more preferably 20 to 95° C., even more preferably 30 to 90° C. If the Tg is lower than the temperature at which the aqueous dispersion slurry coating material is produced, the effect of preventing the occurrence of blocking or aggregation is reduced. It is to be noted that in the present invention, Tg is measured by DSC.

From the viewpoint of suppressing dissolution or swelling of the resin particles (A) in water or a solvent to be used for dispersion, it is preferred that the molecular weight, SP value (calculated in accordance with a method described in Polymer Engineering and Science, February, 1974, Vol. 14, No. 2, p. 147-154), crystallinity, molecular weight between cross-linking points, etc. of the resin (a) are appropriately adjusted.

The number-average molecular weight (measured by GPC; hereinafter, abbreviated as “Mn”) of the resin (a) is usually 1,000 or more, preferably 1,400 or more, and the SP value of the resin (a) is usually 7 to 18, preferably 8 to 14.

A cross-linked structure may be introduced into the resin (a). Such a cross-linked structure may be of any type such as covalent bond type, coordinate bond type, ionic bond type, or hydrogen bond type.

As in the case of the resin (a), the resin (b) to be used in the present invention may be any known resin. Specific examples of the resin (b) are the same as those described with reference to the resin (a). The resin (b) can be appropriately selected according to the purpose of use, but preferred examples of the resin (b) include polyurethane resins, epoxy resins, vinyl resins, and polyester resins. As in the case of the resin (a), the resin (b) also preferably has a reactive functional group.

The number-average molecular weight (hereinafter, also referred to as “Mn”) of the resin (b) is usually 2,000 to 500,000, preferably 4,000 to 200,000. The melting point (measured by DSC; the same goes for the following melting point values) of the resin (b) is usually 0 to 200° C., preferably 35 to 150° C. The Tg of the resin (b) is preferably −50 to 50° C., more preferably −40 to 40° C., even more preferably −37 to 38° C. The SP value of the resin (b) is usually 7 to 18, preferably 8 to 14.

The aqueous dispersion slurry coating material according to the present invention may further contain a surfactant (D) A method for adding the surfactant (D) is not particularly limited, but the surfactant (D) is preferably mixed with the aqueous medium (F).

Examples of the surfactant (D) include an anionic surfactant (D-1), a cationic surfactant (D-2), an amphoteric surfactant (D-3), a nonionic surfactant (D-4), and a reactive surfactant (D-5). These surfactants (D) may be used in combination of two or more of them.

Examples of the anionic surfactant (D-1) include carboxylic acids and salts thereof, sulfuric acid ester salts, salts of carboxymethylation products, sulfonic acid salts, and phosphoric acid ester salts.

Examples of the carboxylic acids and salts thereof include saturated or unsaturated fatty acids having 8 to 22 carbon atoms and salts thereof. Specific examples of such carboxylic acids and salts thereof include capric acid, lauric acid, myristic acid, palmitic acid, stearic acid, arachidic acid, behenic acid, oleic acid, linoleic acid, ricinoleic acid, mixtures of higher fatty acids obtained by saponifying coconut oil, palm kernel oil, rice bran oil, beef tallow, and the like, and sodium salts, potassium salts, ammonium salts, and alkanolamine salts thereof.

Examples of the sulfuric acid ester salts include higher alcohol sulfuric acid ester salts (sulfuric acid ester salts of aliphatic alcohols having 8 to 18 carbon atoms), higher alkyl ether sulfuric acid ester salts (sulfuric acid ester salts of C8 to C18 aliphatic alcohol-ethyleneoxide (1 to 10 mol) adducts), sulfate oils (obtained by direct sulfation of natural unsaturated fats and oils or unsaturated waxes followed by neutralization), sulfated fatty acid esters (obtained by sulfation of lower alcohol esters of unsaturated fatty acids followed by neutralization), and sulfated olefins (obtained by sulfation of olefins having 12 to 18 carbon atoms followed by neutralization). These salts include sodium salts, potassium salts, ammonium salts, and alkanolamine salts. Specific examples of the higher alcohol sulfuric acid ester salts include octyl alcohol sulfuric acid ester salts, decyl alcohol sulfuric acid ester salts, lauryl alcohol sulfuric acid ester salts, stearyl alcohol sulfuric acid ester salts, sulfuric acid ester salts of alcohols synthesized using Ziegler catalyst (e.g., ALFOL 1214 manufactured by CONDEA), and sulfuric acid ester salts of alcohols synthesized by oxo process (e.g., Dobanol 23, 25, and 45 manufactured by Mitsubishi Petrochemical Co., Ltd., Tridecanol manufactured by Kyowa Hakko Kyogyo Co., Ltd., Oxocol 1213, 1215, and 1415 manufactured by Nissan Chemical Industries, and Diadol 115-L, 115-H, and 135 manufactured by Mitsubishi Kasei Corporation). Specific examples of the higher alkyl ether sulfuric acid ester salts include lauryl alcohol-ethylene oxide (2 mol) adduct sulfuric acid ester salts and octyl alcohol-ethyleneoxide (3 mol) adduct sulfuric acid ester salts. Specific examples of the sulfate oils include sodium, potassium, ammonium, and alkanolamine salts of sulfation products of castor oil, peanut oil, olive oil, rape oil, beef tallow, and sheep tallow. Specific examples of the sulfated fatty acid esters include sodium, potassium, ammonium, and alkanolamine salts of sulfation products of butyl oleate and butyl ricinoleate. A specific example of the sulfated olefins includes Teepol (manufactured by Shell Chemicals).

Examples of the salts of carboxymethylation products include salts of carboxymethylation products of aliphatic alcohols having 8 to 16 carbon atoms and salts of carboxymethylation products of C8 to C16 aliphatic alcohol-ethylene oxide (1 to 10 mol) adducts. Specific examples of the salts of carboxymethylation products of aliphatic alcohols include a sodium salt of carboxymethylated octyl alcohol, a sodium salt of carboxymethylated decyl alcohol, a sodium salt of carboxymethylated lauryl alcohol, a sodium salt of carboxymethylated Dobanol 23, and a sodium salt of carboxymethylated tridecanol. Specific examples of the salts of carboxymethylation products of aliphatic alcohol-ethylene oxide (1 to 10 mol) adducts include a sodium salt of carboxymethylation product of octyl alcohol-ethylene oxide (3 mol) adduct, a sodium salt of carboxymethylation product of lauryl alcohol-ethylene oxide (4 mol) adduct, a sodium salt of carboxymethylation product of Dobanol 23-ethylene oxide (3 mol) adduct, and a sodium salt of carboxymethylation product of tridecanol-ethylene oxide (5 mol) adduct.

Examples of the sulfonic acid salts include alkylbenzenesulfonic acid salts, alkylnaphthalenesulfonic acid salts, sulfosuccinic acid diester types, α-olefinsulfonic acid salts, Igepon T-type salts, and other sulfonic acid salts of aromatic ring-containing compounds. A specific example of the alkylbenzenesulfonic acid salts includes dodecylbenzenesulfonic acid sodium salt. A specific example of the alkylnaphthalenesulfonic acid salts includes dodecylnaphthalenesulfonic acid sodium salt. A specific example of the sulfosuccinic acid diester types includes sulfosuccinic acid di-2-ethylhexyl ester sodium salt. Examples of the sulfonic acid salts of aromatic ring-containing compounds include alkylated diphenyl ether mono- or di-sulfonic acid salts and styrenated phenolsulfonic acid salts.

Examples of the phosphoric acid ester salts include higher alcohol phosphoric acid ester salts and higher alcohol-ethylene oxide adduct phosphoric acid ester salts.

Specific examples of the higher alcohol phosphoric acid ester salts include lauryl alcohol phosphoric acid monoester disodium salt and lauryl alcohol phosphoric acid diester sodium salt. A specific example of the higher alcohol-ethylene oxide adduct phosphoric acid ester salts includes oleyl alcohol-ethylene oxide (5 mol) adduct phosphoric acid monoester disodium salt.

Examples of the cationic surfactant (D-2) include a quaternary ammonium salt-type surfactant and an amine salt-type surfactant.

The quaternary ammonium salt-type surfactant can be obtained by reaction between a tertiary amine and a quaternizing agent (e.g., an alkylating agent such as methyl chloride, methyl bromide, ethyl chloride, benzyl chloride, or dimethylsulfuric acid, or ethylene oxide), and examples thereof include lauryltrimethylammonium chloride, didecyldimethylammonium chloride, dioctyldimethylammonium bromide, stearyltrimethylammonium bromide, lauryldimethylbenzylammonium chloride (benzalkonium chloride), cetylpyridinium chloride, polyoxyethylenetrimethylammonium chloride, and stearamidoethyldiethylmethylammonium methosulfate.

The amine salt-type surfactant can be obtained by neutralizing a primary, secondary, or tertiary amine with an inorganic acid (e.g., hydrochloric acid, nitric acid, sulfuric acid, or hydriodic acid) or an organic acid (e.g., acetic acid, formic acid, oxalic acid, lactic acid, gluconic acid, adipic acid, or alkylphosphoric acid). Examples of the primary amine salt-type surfactant include inorganic or organic acid salts of aliphatic higher amines (e.g., higher amines such as laurylamine, stearylamine, cetylamine, hydrogenated beef tallow amine, and rosin amine) and higher fatty acid (e.g., stearic acid, oleic acid) salts of lower amines. Examples of the secondary amine salt-type surfactant include inorganic or organic acid salts of aliphatic amine-ethylene oxide adducts. Examples of the tertiary amine salt-type surfactant include inorganic or organic acid salts of aliphatic amines (e.g., triethylamine, ethyldimethylamine, and N,N,N′,N′-tetramethylethylenediamine), aliphatic amine-ethylene oxide (2 or more mol) adducts, alicyclic amines (e.g., N-methylpyrrolidine, N-methylpiperidine, N-methylhexamethyleneimine, N-methylmorpholine, and 1,8-diazabicyclo(5,4,0)-7-undecene), and nitrogen-containing heterocyclic aromatic amines (e.g., 4-dimethylaminopyridine, N-methylimidazole, and 4,4′-dipyridyl), and inorganic or organic acid salts of tertiary amines such as triethanolamine monostearate and stearamidoethyldiethylmethylethanolamine.

Examples of the amphoteric surfactant (D-3) to be used in the present invention include a carboxylic acid salt-type amphoteric surfactant, a sulfuric acid ester salt-type amphoteric surfactant, a sulfonic acid salt-type amphoteric surfactant, and a phosphoric acid ester salt-type amphoteric surfactant. The carboxylic acid salt-type amphoteric surfactant further includes an amino acid-type amphoteric surfactant and a betaine-type amphoteric surfactant.

Examples of the carboxylic acid salt-type amphoteric surfactant include an amino acid-type amphoteric surfactant, a betaine-type amphoteric surfactant, and an imidazoline-type amphoteric surfactant. The amino acid-type amphoteric surfactant is an amphoteric surfactant having an amino group and a carboxyl group in a molecule, and examples thereof include compounds represented by the following general formula: [R—NH— (CH₂)n-COO]mM, wherein R is a monovalent hydrocarbon group, n is usually 1 or 2, m is 1 or 2, and M is a hydrogen atom, an alkali metal atom, an alkaline-earth metal atom, an ammonium cation, an amine cation, or an alkanolamine cation.

Specific examples of the amino acid-type amphoteric surfactant include alkylaminopropionic acid-type amphoteric surfactants (e.g., sodium stearylaminopropionate and sodium laurylaminopropionate) and alkylaminoacetic acid-type amphoteric surfactants (e.g., sodium laurylaminoacetate).

The betaine-type amphoteric surfactant is an amphoteric surfactant having a quaternary ammonium salt-type cationic moiety and a carboxylic acid-type anionic moiety in a molecule, and examples thereof include alkyldimethylbetaines (e.g., stearyldimethylaminoacetic acid betaine and lauryldimethylaminoacetic acid betaine), amide betaines (e.g., coconut oil fatty acid amidopropyl betaine), and alkyldihydroxyalkyl betaines (e.g., lauryldihydroxyethyl betaine).

An example of the imidazoline-type amphoteric surfactant includes 2-undecyl-N-carboxymethyl-N-hydroxyethylimidazolinium betaine.

Examples of other amphoteric surfactants include glycine-type amphoteric surfactants such as sodium lauroyl glycine, sodium lauryldiaminoethyl glycine, lauryldiaminoethyl glycine hydrochloride, and dioctyldiaminoethyl glycine hydrochloride, and sulfobetaine-type amphoteric surfactants such as pentadecylsulfotaurine.

Examples of the nonionic surfactant (D-4) include an alkylene oxide adduct-type nonionic surfactant and a polyhydric alcohol-type nonionic surfactant.

The alkylene oxide adduct-type nonionic surfactant can be obtained by directly adding an alkylene oxide to a higher alcohol, a higher fatty acid, an alkylamine, or the like, or by reacting a higher fatty acid with a polyalkylene glycol obtained by adding an alkylene oxide to a glycol, or by adding an alkylene oxide to an esterification product obtained by reacting a polyhydric alcohol with a higher fatty acid, or by adding an alkylene oxide to a higher fatty acid amide.

Examples of the alkylene oxide include ethylene oxide, propylene oxide, and butylene oxide. Among these, ethylene oxide and a random or block adduct of ethylene oxide and propylene oxide are preferred. The number of moles of the alkylene oxide to be added is preferably 10 to 50 moles, and the alkylene oxide added preferably contains 50 to 100 wt % of ethylene oxide.

Specific examples of the alkylene oxide adduct-type nonionic surfactant include: oxyalkylene alkyl ethers (e.g., octyl alcohol-ethylene oxide adduct, lauryl alcohol-ethylene oxide adduct, stearyl alcohol-ethylene oxide adduct, oleyl alcohol-ethylene oxide adduct, and lauryl alcohol-ethylene oxide-propylene oxide block adduct); polyoxyalkylene higher fatty acid esters (e.g., stearic acid-ethylene oxide adduct and lauric acid-ethylene oxide adduct); polyoxyalkylene polyhydric alcohol higher fatty acid esters (e.g., polyethylene glycol lauric acid diester, polyethylene glycol oleic acid diester, and polyethylene glycol stearic acid diester); polyoxyalkylene alkylphenyl ethers (e.g., nonylphenol-ethylene oxide adduct, nonylphenol-ethylene oxide-propylene oxide block adduct, octylphenol-ethylene oxide adduct, bisphenol A-ethylene oxide adduct, dinonylphenol-ethylene oxide adduct, and styrenated phenol-ethylene oxide adduct); polyoxyalkylene alkylamino ethers (e.g., laurylamine-ethylene oxide adduct and stearylamine-ethylene oxide adduct); and polyoxyalkyelene alkylalkanolamides (e.g., hydroxyethyllauric acid amide-ethylene oxide adduct, hydroxypropyloleic acid amide-ethylene oxide adduct, and dihydroxyethyllauric acid amide-ethylene oxide adduct).

Examples of the polyhydric alcohol-type nonionic surfactant include polyhydric alcohol fatty acid esters, polyhydric alcohol fatty acid ester-alkylene oxide adducts, polyhydric alcohol alkyl ethers, polyhydric alcohol alkyl ether-alkylene oxide adducts.

Specific examples of the polyhydric alcohol fatty acid esters include pentaerythritol monolaurate, pentaerythritol monooleate, sorbitan monolaurate, sorbitan monostearate, sorbitan dilaurate, sorbitan dioleate, and sucrose monostearate. Specific examples of the polyhydric alcohol fatty acid ester-alkylene oxide adducts include ethylene glycol monooleate-ethylene oxide adduct, ethylene glycol monostearate-ethylene oxide adduct, trimethylolpropane monostearate-ethylene oxide-propylene oxide random adduct, sorbitan monolaurate-ethylene oxide adduct, sorbitan monostearate-ethylene oxide adduct, sorbitan distearate-ethylene oxide adduct, and sorbitan dilaurate-ethylene oxide-propylene oxide random adduct. Specific examples of the polyhydric alcohol alkyl ethers include pentaerythritol monobutyl ether, pentaerythritol monolauryl ether, sorbitan monomethyl ether, sorbitan monostearyl ether, methyl glycoside, and lauryl glycoside. Specific examples of the polyhydric alcohol alkyl ether-alkylene oxide adducts include sorbitan monostearyl ether-ethylene oxide adduct, methyl glycoside-ethylene oxide-propylene oxide random adduct, lauryl glycoside-ethylene oxide adduct, and stearyl glycoside-ethylene oxide-propylene oxide random adduct.

The reactive surfactant (D-5) preferably has at least one group selected from the group consisting of a carboxyl group, a hydroxyl group, an amino group, an isocyanate group, a blocked isocyanate group and an epoxy group, and particularly preferably has such a group in its hydrophilic moiety. From the viewpoint of reactivity, the reactive surfactant having at least one of a hydroxyl group, a blocked isocyanate group, and an amino group is more preferred. The reactive surfactant (D-5) having low compatibility with the reactive functional group-containing resin (a) and/or resin (b) is directly bonded to the resin (a) and/or the resin (b), and therefore has improved compatibility with a coating film so that the aqueous dispersion slurry coating material shows high film strength and excellent cured film properties such as water resistance. In addition, the aqueous dispersion slurry coating material shows excellent dispersion stability of the resin during storage. The surfactant (D-5) is particularly preferably added just before or during dispersing the resin (b) in the aqueous dispersion (G).

Examples of the reactive surfactant (D-5) include urethane resins. The example of the urethane resin as the surfactant contains, as main components, an addition reaction product of a monohydric phenol or a monohydric aromatic alcohol and, if necessary, a vinyl monomer, or an alkylene oxide adduct thereof, an organic diisocyanate, and a diol and/or a diamine each having a polyoxyethylene chain. If necessary, the urethane resin may further contain a chain extender.

The urethane resin as the surfactant has a hydrophobic moiety composed of an addition reaction product of a monohydric phenol or a monohydric aromatic alcohol and, if necessary, a vinyl monomer, and has a hydrophilic moiety composed of a diol and/or a diamine each having a polyoxyethylene chain.

At least one group selected from the group consisting of a carboxyl group, a hydroxyl group, an amino group, an isocyanate group, a blocked isocyanate group, and an epoxy group is bonded to the hydrophobic moiety and/or the hydrophilic moiety of the reactive surfactant (D-5), and is preferably chemically bonded to the side chain and/or the end of the hydrophilic moiety, and is more preferably chemically bonded to the end of the hydrophilic moiety.

The reactive surfactant (D-5) is preferably composed of one or more compounds represented by the following general formulas (1) to (4):

Q-(—CONH-G-NHCO-J-)m-CONH-G-NHCO—Y (1)

Q-(—CONH-G-NHCO-J-)m-Z (2)

Q-(—CONH-G-NHCO-J-)m-OH (3)

Q-(—CONH-G-NHCO-J-)m-NH₂ (4)

wherein Q represents a residue of an addition reaction product of a monohydric phenol or a monohydric aromatic alcohol and, if necessary, a vinyl monomer, or an alkylene oxide adduct thereof, G represents a residue of an organic diisocyanate, J represents a residue of a diol and/or a diamine each having a polyoxyethylene chain, Y represents a residue of a blocking agent, Z represents a residue of a polyepoxy compound, and m is preferably 1 to 20, more preferably 1 to 10, and wherein when two or more Gs are present, they may be the same or different, and when two or more Js are present, they may be the same or different.

The amount of the surfactant (D) contained in the aqueous dispersion slurry coating material according to the present invention is preferably in the range of 0.01 to 20 wt %, more preferably in the range of 0.01 to 15 wt %, particularly preferably in the range of 0.05 to 10 wt % with respect to the weight of the aqueous dispersion slurry coating material from the viewpoints of storage stability and the water resistance of an obtained coating film. The amount of the resin particles (A) contained in the aqueous dispersion slurry coating material is preferably in the range of 0.1 to 60 wt %, more preferably in the range of 0.2 to 50 wt %, even more preferably in the range of 0.3 to 45 wt %, particularly preferably in the range of 0.3 to 40 wt %, very particularly preferably in the range of 0.3 to 20 wt % with respect to the weight of the aqueous dispersion slurry coating material from the viewpoints of storage stability and the smoothness of an obtained coating film.

The weight ratio of the resin particles (A) to the resin particles (B) (i.e., [weight of resin particles (A)]/[weight of resin particles (B)]) is preferably 0.01 or higher from the viewpoint of storage stability, but is preferably 1 or less from the viewpoint of the strength of an obtained coating film. The weight ratio of the resin particles (A) to the resin particles (B) is more preferably in the range of 0.02 to 0.5, even more preferably in the range of 0.03 to 0.3, particularly preferably in the range of 0.03 to 0.2.

The aqueous dispersion slurry coating material according to the present invention may further contain a water-soluble polymer (T) and a solvent (U).

Examples of the water-soluble polymer (T) include cellulose-based compounds (e.g., methyl cellulose, ethyl cellulose, hydroxyethyl cellulose, ethyl hydroxyethyl cellulose, carboxymethyl cellulose, hydroxypropyl cellulose, and saponification products thereof), gelatin, starch, dextrin, gum arabic, chitin, chitosan, polyvinyl alcohol, polyvinyl pyrrolidone, polyethylene glycol, polyethyleneimine, polyacrylamide, acrylic acid (salt)-containing polymers (e.g., sodium polyacrylate, potassium polyacrylate, ammonium polyacrylate, polyacrylic acid partially neutralized with sodium hydroxide, and sodium acrylate-acrylic acid ester copolymer), styrene-maleic anhydride copolymer (partially) neutralized with sodium hydroxide, and water-soluble polyurethanes (e.g., reaction products of polyethylene glycol or polycaprolactone diol with polyisocyanate).

The amount of the water-soluble polymer (T) contained in the aqueous dispersion slurry coating material is preferably in the range of 0 to 15 wt %, more preferably in the range of 0.2 to 10 wt %, particularly preferably in the range of 0.3 to 5 wt % with respect to the weight of the aqueous dispersion slurry coating material from the viewpoint of the water resistance of an obtained coating film.

In the present invention, if necessary, the solvent (U) may be added to the aqueous medium (F) or to a dispersion to be emulsified (an oil phase containing the resin (b)) at the time of emulsification and dispersion. Specific examples of the solvent (U) include: aromatic hydrocarbon-based solvents such as toluene, xylene, ethylbenzene, and tetralin; aliphatic or alicyclic hydrocarbon-based solvents such as n-hexane, n-heptane, mineral spirit, and cyclohexane; halogen-based solvents such as methyl chloride, methyl bromide, methyl iodide, methylene dichloride, carbon tetrachloride, trichloroethylene, and perchloroethylene; ester- or ester ether-based solvents such as ethyl acetate, butyl acetate, methoxybutyl acetate, methylcellosolve acetate, and ethylcellosolve acetate; ether-based solvents such as diethyl ether, tetrahydrofuran, dioxane, ethyl cellosolve, butyl cellosolve, and propylene glycol monomethyl ether; ketone-based solvents such as acetone, methyl ethyl ketone, methyl isobutyl ketone, di-n-butyl ketone, and cyclohexanone; alcohol-based solvents such as methanol, ethanol, n-propanol, isopropanol, n-butanol, isobutanol, t-butanol, 2-ethylhexyl alcohol, and benzyl alcohol; amide-based solvents such as dimethyl formamide and dimethyl acetamide; sulfoxide-based solvents such as dimethylsulfoxide; heterocyclic compound-based solvents such as N-methylpyrrolidone; and mixed solvents of two or more of these solvents.

The amount of the solvent (U) contained in the aqueous dispersion slurry coating material is in the range of 0 to 10 wt %, more preferably in the range of 0.1 to 8 wt %, particularly preferably in the range of 0.2 to 5 wt % with respect to the weight of the aqueous dispersion slurry coating material from the viewpoint of storage stability.

The aqueous medium (F) refers to water or a mixed solvent of a water-miscible solvent (F0) and water. Examples of the water-miscible solvent (F0) include alcohol-based solvents and ketone-based solvents. Specific examples of the alcohol-based solvents include methanol, isopropanol, ethanol, and n-propanol, and specific examples of the ketone-based solvents include acetone and methyl ethyl ketone. The mixing ratio between water and the water-miscible solvent is preferably in the range of 100/0 to 100/20, more preferably in the range of 100/0 to 100/5.

The amount of the aqueous medium (F) contained in the aqueous dispersion slurry coating material is preferably in the range of 10 to 90 wt %, more preferably in the range of 15 to 85 wt %, particularly preferably in the range of 20 to 80 wt % with respect to the weight of the aqueous dispersion slurry coating material from the viewpoints of storage stability and the coating properties of the coating material.

In the present invention, a curing agent (E) can be further used. A method for adding the curing agent (E) is not particularly limited, but the curing agent (E) is preferably melt-kneaded with the resin (b) or is preferably mixed with a solution obtained by dissolving the resin (b) in a solvent (y). Examples of the solvent (y) include solvents exemplified above as the solvent (U).

The curing agent (E) to be used in the present invention preferably has a reactive functional group which can react with the reactive functional group contained in the resin (a) and/or the resin (b).

Examples of the curing agent (E) include a curing agent (e1) having two or more carboxyl groups in one molecule, a curing agent (e2) having two or more epoxy groups in one molecule, a curing agent (e3) having two or more amino groups in one molecule, a curing agent (e4) having two or more hydroxyl groups in one molecule, a curing agent (e5) having two or more isocyanate groups in one molecule, a curing agent (e6) having two or more hydrolyzable silyl groups in one molecule, a curing agent (e7) having two or more blocked amino groups in one molecule, a curing agent (e8) having two or more blocked isocyanate groups in one molecule, and mixtures of two or more of these curing agents. Specific examples of the curing agent (E) are as follows:

(e1) The polycarboxylic acids mentioned above with reference to the polyester resins;

(e2) The epoxy resins mentioned above;

(e3) The diamines and polyamines mentioned above with reference to the polyurethane resins;

(e7) The blocked curing agent (e3) [examples of a blocking agent include ketones having 3 to 8 carbon atoms (e.g., acetone, methyl ethyl ketone, and methyl isobutyl ketone) and acid anhydrides having 4 to 10 carbon atoms (e.g., phthalic anhydride)];

(e4) The polyhydric alcohols, polyester polyols having a hydroxyl group at each end, acrylic polyols, and polyether polyols mentioned above;

(e5) The above-mentioned bifunctional or higher functional polyisocyanates and reaction products thereof;

(e8) The blocked curing agent (e5) [examples of a blocking agent include those mentioned above and secondary amines having 4 to 20 carbon atoms (e.g., diethylamine and di-n-butylamine), basic nitrogen-containing compounds having 4 to 20 carbon atoms (e.g., N,N-diethylhydroxyamine, 2-hydroxypyridine, pyridine N-oxide, and 2-mercaptopyridine), and active methylene group-containing compounds having 5 to 15 carbon atoms (e.g., diethyl malonate, methyl acetoacetate, ethyl acetoacetate, and acetylacetone); examples of the blocked curing agent include not only those obtained by blocking an isocyanate group with the blocking agent mentioned above but also oligomers obtained by polymerizing a diisocyanate (urethodione-type blocked isocyanate group-containing compounds), such as oligomers (degree of polymerization: 2 to 15) of HDI or TDI, and compounds having a structure obtained by reacting the terminal isocynate group of the oligomer with the blocking agent mentioned above]; and

(e6) C1 to C8 alkoxy group-containing di-, tri-, and tetraalkoxysilanes and condensation products thereof.

Among these curing agents (E), the curing agents (e1), (e5), (e6), and (e8) are preferred, and dodecanedioic acid, trimethoxysilane, and ε-caprolactam blocked isophoronediisocyanate are more preferred from the viewpoint of reactivity.

From the viewpoint of the strength of an obtained coating film, preferred examples of a combination of the reactive functional group of the resin (a) and/or the resin (b) and the reactive functional group of the curing agent (E) include a combination of epoxy group/carboxyl group and the reverse thereof and a combination of hydroxyl group/blocked isocyanate group and the reverse thereof, and more preferred examples of the combination include a combination of glycidyl group/carboxyl group and the reverse thereof and a combination of hydroxyl group/urethodione-type blocked isocyanate group and the reverse thereof.

The equivalent ratio between the reactive functional group of the resin (a) and/or the resin (b) and the reactive functional group of the curing agent (E) is preferably in the range of 1/0 to 1/1.4, more preferably in the range of 1/0.5 to 1/1.2, particularly preferably in the range of 1/0.9 to 1/1.1 from the viewpoint of the stability with lapse of time of the resin.

The curing agent (E) may be added to the aqueous dispersion slurry coating material according to the present invention by allowing it to be contained in at least one kind selected from the group consisting of the resin particles (A), the resin particles (B), and the aqueous medium (F).

The reaction of the resin (a) and/or the resin (b) with the curing agent (E) may be carried out in the presence of a curing catalyst. For example, in a case where a combination of the reactive functional group of the resin (a) and/or the resin (b) and the reactive functional group of the curing agent (E) is hydroxyl group/(blocked) isocyanate group or the reverse thereof, examples of the curing catalyst include catalysts usually used for urethanization reaction [e.g., metallic catalysts such as tin-based catalysts (e.g., dibutyltin dilaurate and stannous octoate) and lead-based catalysts (e.g., lead oleate, lead naphthenate, and lead octenate), and amine-based catalysts (e.g., triethylenediamine and dimethylethanolamine)]. In the case of a combination of carboxyl group/epoxy group or the reverse thereof, examples of the curing catalyst include acids (e.g., boron trifluoride), bases (e.g., amines and alkaline-earth metal hydroxides), salts (e.g., quaternary onium salts), and organometallic catalysts (e.g., stannous chloride and tetrabutyl zirconate). In the case of a combination of hydroxyl group/amino group or the reverse thereof, examples of the curing catalyst include organic acids (e.g., p-toluenesulfonic acid and dodecylbenzenesulfonic acid) and inorganic acids (e.g., phosphoric acid).

In the case of using the curing catalyst, the amount of the curing catalyst to be used is preferably 1 wt % or less, more preferably in the range of 0.005 to 0.8 wt %, particularly preferably in the range of 0.01 to 0.5 wt % with respect to the total weight of the aqueous dispersion slurry coating material from the viewpoint of the curing properties of an obtained coating film.

Further, in the case of using the curing catalyst, the curing catalyst may be added to the aqueous dispersion slurry coating material according to the present invention by allowing it to be contained in at least one kind selected from the group consisting of the resin particles (A), the resin particles (B), and the aqueous medium (F).

If necessary, the aqueous dispersion slurry coating material according to the present invention may further contain one or more other additives usually used in the field of coating materials, such as a leveling agent, a coloring agent, an antioxidant, a rheology control agent, a film-forming aid, and a plasticizer, as long as the effects of the present invention are not impaired. The one or more other additives may be added to the aqueous dispersion slurry coating material according to the present invention by allowing it or them to be contained in at least one kind selected from the group consisting of the resin particles (A), the resin particles (B), and the aqueous medium (F), or may be separately added to and mixed with the aqueous dispersion slurry coating material according to the present invention.

Examples of the leveling agent include olefin-based polymers having a weight-average molecular weight (hereinafter, also referred to as “Mw”) of 500 to 5,000 (e.g., low molecular weight polyethylene and low molecular weight polypropylene), olefin-based copolymers having a Mw of 500 to 20,000 [e.g., ethylene-acrylic (e.g., acrylonitrile) copolymers and ethylene-methacrylic copolymers], (meth)acrylic copolymers having a Mw of 1,000 to 20,000 (e.g., Modaflow (trade name) manufactured by Solutia), polyvinyl pyrrolidone (Mw: 1,000 to 20,000), silicone-based leveling agents having a Mw of 1,000 to 20,000 [e.g., polydimethylsiloxane, polyphenylsiloxane, organic (carboxyl, ether, or epoxy)-modified polydimethylsiloxanes, and fluorinated silicones], low molecular compounds (e.g., benzoin), and mixtures of two or more of them.

The amount of the leveling agent to be used is usually 5% or less, preferably 0.3 to 3% with respect to the total weight of the aqueous dispersion slurry coating material.

Examples of the coloring agent include inorganic pigments, organic pigments, and dyes.

Examples of the inorganic pigments include white pigments (e.g., titaniumoxide, lithopone, white lead, and hydrozincite), cobalt compounds (e.g., aureolin, cobalt green, cerulean blue, cobalt blue, and cobalt violet), iron compounds (e.g., iron oxide and iron blue), chromium compounds (e.g., chromium oxide, lead chromate, and barium chromate), sulfides (e.g., cadmium sulfide, cadmium yellow, and ultramarine), and mixtures of two or more of them.

Examples of the organic pigments include: azo pigments such as azo lake pigments, monoazo pigments, disazo pigments, and chelate azo pigments; polycyclic pigments such as benzimidazolone-based pigments, phthalocyanine-based pigments, quinacridon-based pigments, dioxazine-based pigments, isoindolinone-based pigments, thioindigo-based pigments, perylene-based pigments, quinophthalone-based pigments, and anthraquinone-based pigments; and mixtures of two or more of them.

Examples of the dyes include azo dyes, anthraquinone-based dyes, indigoid-based dyes, sulfide-based dyes, triphenylmethane-based dyes, pyrazolone-based dyes, stilbene-based dyes, diphenylmethane-based dyes, xanthene-based dyes, alizarin-based dyes, acridine-based dyes, quinone imine-based dyes, thiazole-based dyes, methine-based dyes, nitro dyes, nitroso dyes, aniline-based dyes, and mixtures of two or more of them.

The amount of the coloring agent to be used varies depending on the kind thereof, but is usually 30% or less, preferably 5 to 25% with respect to the total weight of the aqueous dispersion slurry coating material.

Examples of the antioxidant include: phenol-based antioxidants [e.g., 2,6-di-t-butyl-p-cresol (BHT), 2,2′-methylenebis(4-methyl-6-t-butylphenol), and tetrakis[methylene-(3,5-di-t-butyl-4-hydroxyhydrocinnamate) ]methane (e.g., Irganox 1010 (trade name) manufactured by Ciba Geigey)]; sulfur-based antioxidants [e.g., dilauryl 3,3′-thiodipropionate (DLTDP) and distearyl 3,3′-thiodipropionate (DSTDP)]; phosphorus-based antioxidants [e.g., triphenylphosphite (TPP) and triisodecylphosphite (TDP)]; amine-based antioxidants (e.g., octylated diphenylamine, N-n-butyl-p-aminophenol, and N,N-diisopropyl-p-phenylenediamine); and mixtures of two or more of them.

The amount of the antioxidant to be used is usually 5% or less, preferably 0.1 to 2% with respect to the total weight of the aqueous dispersion slurry coating material.

Examples of the rheology control agent include: urethane-modified association-type rheology control agents; inorganic viscosity control agents (e.g., silicate of soda and bentonite); cellulose-based viscosity control agents usually having an Mw of 20,000 or more (e.g., methyl cellulose, carboxymethyl cellulose, and hydroxymethyl cellulose); protein-based rheology control agents (e.g., casein, casein soda, and casein ammonium); acrylic rheology control agents usually having an Mw of 20,000 or more (e.g., sodium polyacrylate and ammonium polyacrylate); and vinyl rheology control agents usually having an Mw of 20,000 or more (e.g., polyvinyl alcohol).

The amount of the rheology control agent to be used is usually 10% or less, preferably 0.1 to 5% with respect to the total weight of the aqueous dispersion slurry coating material.

As the film-forming aid, for example, a hydrophilic alcohol- or ester-based solvent having a high boiling point is preferred from the viewpoint of practical use. Specific examples of such a film-forming aid include ethylene glycol, texanol, diethyl adipate, ethylene glycol hexyl ether, propylene glycol pentyl ether, dipropylene glycol-n-butyl ether, and texanol isobutyl ether.

The amount of the film-forming aid to be used is usually 15% or less, preferably 1 to 10% with respect to the total weight of the aqueous dispersion slurry coating material.

A method for producing the aqueous dispersion slurry coating material according to the present invention is not particularly limited, but the following methods (1) to (3) are preferred:

(1) a method in which the resin (b) is dispersed in a dispersion obtained by dispersing resin particles (A) comprising the resin (a) in the aqueous medium (F) to thereby form resin particles (B), (2) a method in which a dispersion obtained by dispersing resin particles (A) comprising the resin (a) in the aqueous medium (F) and a dispersion obtained by dispersing resin particles (B) comprising the resin (b) in the aqueous medium (F) are mixed together, and (3) a method in which the resin (a) is dispersed in a dispersion obtained by dispersing resin particles (B) comprising the resin (b) in the aqueous medium (F).

A method for dispersing resin particles (A) comprising the resin (a) in the aqueous medium (F) or in the resin particle (B) dispersion is not particularly limited, but the following methods (1) to (8) are preferred:

(1) in the case of vinyl resins, a method in which resin particles (A) are directly formed by polymerization reaction such as suspension polymerization, emulsion polymerization, seed polymerization, or dispersion polymerization using a monomer as a starting material in the presence of an emulsifier or a dispersing agent; (2) in the case of polyaddition or condensation resins such as polyester resins, polyurethane resins, and epoxy resins, a method in which a precursor (e.g., a monomer or an oligomer) or a solvent solution thereof is dispersed in the aqueous medium (F) or in the resin particle (B) dispersion in the presence of an appropriate dispersing agent, and is then cured by heating or adding a curing agent to form resin particles (A); (3) in the case of polyaddition or condensation resins such as polyester resins, polyurethane resins, and epoxy resins, a method in which an appropriate emulsifier is dissolved in a precursor (e.g., a monomer or an oligomer) or a solvent solution thereof (preferably a liquid, but may be liquefied by heating), and then the aqueous medium (F) or the resin particle (B) dispersion is added thereto to cause phase-inversion emulsification; (4) a method in which a resin previously prepared by polymerization reaction (which may be carried out by any polymerization reaction method such as addition polymerization, ring-opening polymerization, polyaddition, addition condensation, or condensation polymerization) is pulverized using a mechanical rotary- or jet-type pulverizer, and is then classified to obtain resin particles, and the resin particles are dispersed in the aqueous medium (F) or in the resin particle (B) dispersion in the presence of an appropriate dispersing agent; (5) a method in which a resin solution obtained by dissolving a resin previously prepared by polymerization reaction (which may be carried out by any polymerization reaction method such as addition polymerization, ring-opening polymerization, polyaddition, addition condensation, or condensation polymerization) in a solvent is atomized to obtain resin particles, and the resin particles are dispersed in the aqueous medium (F) or in the resin particle (B) dispersion in the presence of an appropriate dispersing agent; (6) a method in which a resin is previously prepared by polymerization reaction (which may be carried out by any polymerization reaction method such as addition polymerization, ring-opening polymerization, polyaddition, addition condensation, or condensation polymerization), resin particles are precipitated by adding a poor solvent to a resin solution obtained by dissolving the resin in a solvent or by cooling a resin solution previously prepared by thermally dissolving the resin in a solvent, the solvent is removed to obtain resin particles, and the resin particles are dispersed in the aqueous medium (F) or in the resin particle (B) dispersion in the presence of an appropriate dispersing agent; (7) a method in which a resin solution obtained by dissolving a resin previously prepared by polymerization reaction (which may be carried out by any polymerization reaction method such as addition polymerization, ring-opening polymerization, polyaddition, addition condensation, or condensation polymerization) in a solvent is dispersed in the aqueous medium (F) or in the resin particle (B) dispersion in the presence of an appropriate dispersing agent, and then the solvent is removed by heating or decompression; and (8) a method in which an appropriate emulsifier is dissolved in a resin solution obtained by dissolving a resin previously prepared by polymerization reaction (which may be carried out by any polymerization reaction method such as addition polymerization, ring-opening polymerization, polyaddition, addition condensation, or condensation polymerization) in a solvent, and then the aqueous medium (F) or the resin particle (B) dispersion is added thereto to cause phase-inversion emulsification.

As the emulsifier or the dispersing agent to be used in the methods (1) to (8), the surfactant (D) conventionally known can be used. In addition, the emulsifier or the dispersing agent may be used together with an emulsification aid or a dispersion aid such as the water-soluble polymer (T) or the solvent (U).

A method for dispersing resin particles (B) comprising the resin (b) in the aqueous medium (F) or in the resin particle (A) dispersion is not particularly limited, but the same methods as described above with reference to the method for dispersing resin particles (A) are preferred.

More specifically, the method for producing an aqueous dispersion slurry coating material according to the present invention preferably includes, for example, two or three steps of the following first to third steps: a first step of forming an aqueous dispersion (G) containing a surfactant (D) and, dispersed in (G), resin particles (A) comprising a resin (a); and a second step of adding and dispersing a resin (b) or a solution obtained by dissolving the resin (b) in a solvent (y) to and in the aqueous dispersion (G); and a third step of removing the solvent (y) to form resin particles (B) comprising the resin (b) in a case where the resin (b) has been dissolved in the solvent (y).

Hereinafter, the respective steps will be described in order.

In the first step, an aqueous dispersion (G) containing a surfactant (D) and, dispersed in (G), resin particles (A) comprising a resin (a) is formed.

A method for forming an aqueous dispersion (G) containing a surfactant (D) and, dispersed in (G), resin particles (A) comprising a resin (a) is not particularly limited, but the above-described methods (1) to (8) are preferred.

According to the method for producing an aqueous dispersion slurry coating material of the present invention, the amount of the aqueous medium (F) constituting the aqueous dispersion (G) is preferably in the range of 10 to 90 wt %, more preferably in the range of 15 to 85 wt %, particularly preferably in the range of 20 to 80 wt % with respect to the weight of the aqueous dispersion (G) from the viewpoints of storage stability and the coating properties of an obtained coating material. The amount of the surfactant (D) is preferably in the range of 0.01 to 20 wt %, more preferably in the range of 0.01 to 15 wt %, particularly preferably in the range of 0.05 to 10 wt % with respect to the weight of the aqueous dispersion (G) from the viewpoints of storage stability and the water resistance of an obtained coating film. Further, the amount of the resin particles (A) is preferably in the range of 0.1 to 60 wt %, more preferably in the range of 0.2 to 50 wt %, particularly preferably in the range of 0.3 to 45 wt % with respect to the weight of the aqueous dispersion (G) from the viewpoints of storage stability and the smoothness of an obtained coating film. Further, the amount of the water-soluble polymer (T) is preferably in the range of 0 to 15 wt %, more preferably in the range of 0.2 to 10 wt %, particularly preferably in the range of 0.3 to 5 wt % with respect to the weight of the aqueous dispersion (G) from the viewpoint of the water resistance of an obtained coating film. Further, the amount of the solvent (U) is in the range of 0 to 10 wt %, more preferably in the range of 0.1 to 8 wt %, particularly preferably in the range of 0.2 to 5 wt % with respect to the weight of the aqueous dispersion (G) from the viewpoint of storage stability.

In the production method according to the present invention, each of the aqueous medium (F), the surfactant (D), the water-soluble polymer (T), and the solvent (U) constituting the aqueous dispersion (G) may be added in an amount within the above range after the formation of resin particles (A) but before the second step.

In the second step, a resin (b) or a solution obtained by dissolving the resin (b) in a solvent (y) is added to and dispersed in the aqueous dispersion (G).

As described above, the second step is a step of adding and dispersing a resin (b) or a solution obtained by dissolving the resin (b) in a solvent (y) to and in the aqueous dispersion (G). The resin (b) is added to the aqueous dispersion (G) and dispersed therein to thereby form resin particles (B) comprising the resin (b). On the other hand, in a case where a solution obtained by dissolving the resin (b) in a solvent (y) is used, resin particles (B) are formed by carrying out the third step. Examples of a method for dispersing the resin (b) in the aqueous dispersion (G) include: (1) a method in which resin particles (B) comprising the resin (b) are dispersed in the aqueous dispersion (G); (2) a method in which the molten resin (b) is dispersed in the aqueous dispersion (G); and (3) a method in which a solvent solution containing the resin (b) dissolved therein is dispersed in the aqueous dispersion (G). Among these methods (1) to (3), the method (3) is preferred from the viewpoint of storage stability. It is to be noted that one or more of the aqueous medium (F), the surfactant (D), the water-soluble polymer (T), and the solvent (U) constituting the aqueous dispersion (G), for example the surfactant (D), may be added in an amount within the above range when the resin (b) or a solution obtained by dissolving the resin (b) in a solvent (y) is dispersed after the formation of resin particles (A).

In the case of the method (2), the resin (b) which is liquid at room temperature or the resin (b) melt by heating is dispersed in the aqueous dispersion (G). The temperature for melting the resin (b) is usually in the range of 0 to 140° C., preferably in the range of 5 to 80° C. from the viewpoint of productivity.

In the case of the method (3), a solution obtained by dissolving the resin (b) in a solvent (y) is added to and dispersed in the aqueous dispersion (G). Specific examples of the solvent (y) include the solvents exemplified above as the solvent (U) The difference in SP value between the solvent (y) and the resin (b) is preferably 3 or less. From the viewpoint of storage stability, the solvent (y) is preferably a solvent which can dissolve the resin (b) but hardly dissolve or swell the resin particles (A) comprising the resin (a). From the viewpoint of productivity, the concentration of the resin (b) to be dissolved in the solvent (y) is in the range of 5 to 90 wt %, preferably in the range of 10 to 85 wt %, most preferably in the range of 20 to 80 wt % with respect to the weight of the solvent (y).

The temperature and pressure, at which the resin (b) is dispersed in the aqueous dispersion of resin particles (A), are usually in the range of 0 to 150° C., preferably in the range of 5 to 98° C. and usually in the range of 0 to 1 MPa, preferably in the range of 0 to 0.8 MPa, respectively. The viscosity of the dispersion is preferably in the range of 1 to 1,000,000 mPa·s.

In a case where the resin (b) or a solvent solution thereof and/or the resin (a) or a solvent solution thereof is/are dispersed, a dispersing device can be used. The dispersing device is not particularly limited as long as it is generally commercially available as an emulsifying machine or a dispersing machine, and examples thereof include: batch-type emulsifying machines such as Homogenizer (manufactured by IKA), Polytron (manufactured by Kinematica), and TK Auto Homomixer (manufactured by Tokushu Kika Kogyo Co., Ltd.); continuous emulsifying machines such as Ebara Milder (manufactured by Ebara Corporation), TK Filmics and TK Pipeline Homomixer (manufactured by Tokushu Kika Kogyo Co., Ltd.), Coloid Mill (manufactured by Shinko Pantec Co., Ltd.), Slusher and Trigonal Wet Pulverizer (manufactured by Mitsui Miike Machinery Co., Ltd.), Cavitron (manufactured by Eurotec), and Fine Flow Mill (manufactured by Pacific Machinery & Engineering Co., Ltd.); high-pressure emulsifying machines such as Microfluidizer (manufactured by Mizuho Industrial Co., Ltd.), Nanomizer (manufactured by Nanomizer), and APV Gaulin (manufactured by Gaulin); membrane emulsifying machines such as Membrane Emulsifier (manufactured by Reica Co., Ltd); vibration-type emulsifying machines such as Vibro Mixer (manufactured by Reica Co., Ltd.); and ultrasonic emulsifying machines such as Ultrasonic Homogenizer (manufactured by Branson). Among them, APV Gaulin, Homogenizer, TK Auto Homomixer, Ebara Milder, TK Filmics, and TK Pipeline Homomixer are preferred from the viewpoint of particle size uniformity.

In a case where the resin (b) or a solvent solution thereof is dispersed in the aqueous dispersion (G), a continuous dispersing machine can be used. In this case, APV Gaulin, Ebara Milder, TK Filmics, TK Pipeline Homomixer, or the like is preferably used. In addition, it is preferred that the resin (b) or a solvent solution thereof and the aqueous dispersion (G) are separately stored in different containers, and a constant amount of the resin (b) or a solvent solution thereof and a constant amount of the aqueous dispersion (G) are fed into the dispersing machine to disperse the resin (b) or a solvent solution thereof in the aqueous dispersion (G).

The amount of the resin (b) contained in the aqueous dispersion (G) is preferably in the range of 5 to 80 wt %, more preferably in the range of 10 to 70 wt % with respect to the weight of the aqueous dispersion (G) from the viewpoint of storage stability.

The amount of a solvent (y) solution of the resin (b) contained in the aqueous dispersion (G) is preferably in the range of 5 to 80 wt %, more preferably in the range of 10 to 70 wt % with respect to the weight of the aqueous dispersion (G) from the viewpoint of productivity.

According to the production method of the present invention, the Tg of the resin (b) is usually in the range of −50 to 50° C., preferably in the range of −40 to 40° C., more preferably in the range of −37 to 38° C.

Preferred examples of a combination of resin (a)/resin (b)/solvent (y) include: (1) (a) vinyl resin/(b) epoxy resin/(y) ethyl acetate; (2) (a) cross-linked vinyl resin/(b) vinyl resin/(y) toluene; (3)(a) polypropylene/(b)polyurethane/(y) methyl ethyl ketone; and (4) (a) polyethylene/(b) polyester/(y) acetone. Among these combinations, the combinations (1) and (2) are preferred from the viewpoint of the physical properties of an obtained coating film.

In a case where a solvent solution obtained by dissolving the resin (a) or the resin (b) in the solvent (y) is used to disperse resin particles, the solvent (y) is removed to form resin particles (B) comprising the resin (b) or resin particles (A) comprising the resin (a). The third step of the production method according to the present invention is a step of removing the solvent (y) to form resin particles (B) comprising the resin (b) in a case where the resin (b) has been dissolved in the solvent (y). As described above, the third step is carried out in a case where the resin (b) has been dissolved in the solvent (y) In this case, resin particles (B) are formed by carrying out the third step.

A method for removing the solvent (y) is not particularly limited, and a well-known method can be used. For example, any one of the following methods (1) to (3) or a combination of two or more of these methods can be used.

(1) A method in which the solvent is removed by heating and/or decompression using a stirred tank for removing a solvent or a film evaporator generally used.

(2) A method in which the solvent is removed by blowing air onto the surface of a liquid or into a liquid.

(3) A method in which the dispersion containing the solvent (y) is diluted with the aqueous medium (F) to extract the solvent (y) into a water continuous phase.

In the case of the method (1), when the resin (a) or the resin (b) is crystalline, the heating temperature is preferably the melting point (Tm) of the resin (a) or the resin (b) or lower, and when the resin (a) or the resin (b) is amorphous, the heating temperature is preferably the glass transition temperature (Tg) of the resin (a) or the resin (b) or lower. More specifically, the heating temperature is usually preferably lower than the Tm or Tg by 5° C. or more, more preferably by 10° C. or more, particularly preferably by 20° C. or more. In a case where the solvent is removed by decompression, the degree of vacuum (gage pressure) is preferably −0.03 MPa or less, more preferably −0.05 MPa or less.

The method (3) is preferably used when the solvent (y) is water-soluble. In general, the method (1) is preferably used.

From the viewpoint of productivity, the solvent (y) is preferably removed within 48 hours, more preferably within 36 hours, most preferably within 30 hours.

The amount of the solvent (y) remaining in the aqueous dispersion slurry coating material is preferably 5 wt % or less, more preferably 4 wt % or less, most preferably 3 wt % or less with respect to the weight of the aqueous dispersion slurry coating material.

Further, according to the production method of the present invention, the amount of the solvent (y) remaining in the aqueous dispersion (G) is preferably 10 wt % or less, more preferably 8 wt % or less, most preferably 5 wt % or less with respect to the weight of the aqueous dispersion (G).

The volume-average particle diameter D_{B} of resin particles (B) (hereinafter, simply referred to as “D_{B}”) contained in the aqueous dispersion slurry coating material produced by the production method according to the present invention is preferably 0.3 μm or more and 10 μm or less. From the viewpoint of the strength of an obtained coating film, the D_{B} is more preferably 0.7 μm or more, even more preferably 0.9 μm or more, particularly preferably 1 μm or more. From the viewpoint of the smoothness of an obtained coating film, the D_{B} is more preferably 8 μm or less, even more preferably 5 μm or less.

The D_{B} can be measured by a flow-type particle image analyzer (FPIA-2100 manufactured by Sysmex Corporation; a sample is prepared by diluting the aqueous dispersion slurry coating material 400-fold with ion-exchanged water).

The aqueous dispersion slurry coating material produced by the production method according to the present invention has a particle size ratio of [volume-average particle diameter D_{A} (hereinafter, simply referred to as “D_{A}”) of resin particles (A)]/[D_{B}] of 0.003 to 0.3. If the ratio of D_{A}/D_{B} is less than 0.003, the aqueous dispersion slurry coating material cannot show sufficient storage stability. On the other hand, if the ratio of D_{A}/D_{B} exceeds 0.3, the smoothness of an obtained coating film is poor. The ratio of D_{A}/D_{B} is preferably in the range of 0.004 to 0.2, more preferably in the range of 0.005 to 0.1. The ratio of D_{A}/D_{B} can be adjusted by controlling the number of rotations (e.g., rpm) for stirring during the formation of resin particles (B).

The volume-average particle diameter D_{A} of the resin particles (A) can be appropriately adjusted to a value suitable for achieving desired storage stability, as long as the particle size ratio is in the above range. For example, in a case where resin particles (B) having a volume-average particle diameter of 1 μm are desired to be obtained, the volume-average particle diameter D_{A} of resin particles (A) is preferably in the range of 0.001 to 0.3 μm, more preferably in the range of 0.002 to 0.2 μm, particularly preferably in the range of 0.005 to 0.1 μm.

The amount of each of the resin (a), the resin (b), the aqueous medium (F), and the surfactant (D) contained in the aqueous dispersion slurry coating material produced by the production method according to the present invention with respect to the weight of the aqueous dispersion slurry coating material is as follows.

The amount of the resin (a) contained in the aqueous dispersion slurry coating material is preferably in the range of 0.1 to 60 wt %, more preferably in the range of 0.2 to 50 wt %, particularly preferably in the range of 0.3 to 45 wt % from the viewpoint of the transparency of an obtained coating film.

The amount of the resin (b) contained in the aqueous dispersion slurry coating material is preferably in the range of 10 to 60 wt %, more preferably in the range of 15 to 58 wt %, particularly preferably in the range of 20 to 55 wt % from the viewpoint of the strength of an obtained coating film.

The amount of the aqueous medium (F) contained in the aqueous dispersion slurry coating material is preferably in the range of 10 to 88 wt %, more preferably in the range of 15 to 85 wt %, particularly preferably in the range of 20 to 80 w % from the viewpoints of storage stability and the coating properties of an obtained coating material.

The amount of the surfactant (D) contained in the aqueous dispersion slurry coating material is preferably in the range of 0.01 to 20 wt %, more preferably in the range of 0.01 to 15 wt %, particularly preferably in the range of 0.05 to 10 wt % from the viewpoints of storage stability and the water resistance of an obtained coating film.

In the present invention, the solid content of the aqueous dispersion slurry coating material may be adjusted by adding or removing the aqueous medium (F). A method for removing the aqueous medium (F) is not particularly limited, and the method described above with reference to the method for removing the solvent (y) can be used.

The solid content of the aqueous dispersion slurry coating material is usually preferably in the range of 5 to 80 wt %, more preferably in the range of 8 to 75 wt %, most preferably in the range of 10 to 70 wt % from the viewpoint of the coating properties of an obtained coating material.

The aqueous dispersion slurry coating material according to the present invention can be applied using a spray coating machine conventionally used as a coating machine for aqueous coating materials or for solvent coating materials, and therefore does not require a novel coating machine.

The coating film of the aqueous dispersion slurry coating material can be formed by spray coating an object with the aqueous dispersion slurry coating material so that an obtained wet coating film can have a thickness of 10 μm or more and 200 μm or less, preferably 10 μm or more and 50 μm or less, and then by heating the wet coating film at a temperature of 100° C. or higher and 200° C. or less, preferably 120° C. or higher and 180° C. or less for 5 minutes or longer but 60 minutes or less, preferably 5 minutes or longer and 30 minutes or less, more preferably 5 minutes or longer and 20 minutes or less.

The thickness of a coating film obtained by applying the aqueous dispersion slurry coating material according to the present invention onto an object and then baking it is 10 μm or more and 150 μm or less, preferably 15 μm or more and 50 μm or less.

### EXAMPLES

Hereinafter, the present invention will be further described with reference to the following examples, but the present invention is not limited to these examples. It is to be noted that in the following description, the term “part(s)” represents part(s) by weight.

### Production Example 1

A reaction vessel equipped with a stirrer, a dropping funnel, a nitrogen gas-introducing tube, a thermometer, and a reflux condenser was prepared, and 53 parts of 4-α-cumylphenol and 23 parts of a Lewis acid catalyst (manufactured by Mizusawa Industrial Chemicals, Ltd. under the trade name of “Galleon Earth”) were placed in the reaction vessel. The air in the reaction system was replaced with nitrogen gas under stirring, and the materials contained in the reaction vessel were heated to 90° C. At the same temperature, 181 parts of styrene was dropped into the reaction vessel in 3 hours, and then the materials contained in the reaction vessel were reacted at the same temperature for 5 hours. The reaction mixture was cooled to 30° C., and then the catalyst was separated by filtration to obtain 220 parts of an addition reaction product of 7 moles of styrene and 1 mole of 4-α-cumylphenol (Mw: 900). Then, 22.1 parts of an ethylene oxide (hereinafter, abbreviated as “EO”) adduct of the addition reaction product (EO content: 45%, Mw: 1,800), 73.7 parts of polyethylene glycol (Mw: 6,000), 4.1 parts of hexamethylenediisocyanate (hereinafter, abbreviated as “HDI”), and 0.4 part of methyl ethyl ketone oxime (hereinafter, abbreviated as MEK oxime) were reacted at 80° C. for 3 hours to obtain 100 parts of a blocked isocyanate group-containing reactive surfactant (D-1) having an average Mw of polyoxyethylene chain of 5,500, an oxyethylene unit content of 87 wt %, an Mw of 30,000, a number of carbon atoms of a hydrocarbon group in a hydrophobic moiety of 71, and an HLB of 16.6.

### Production Example 2

Friedel-Crafts reaction was carried out in the same manner as in the Production Example 1 to obtain a hydroxyl group-containing hydrocarbon [an EO adduct of an addition reaction product of 2 moles of styrene and 1 mole of 4-α-cumylphenol (EO content: 20%), Mw: 800], and 5.9 parts of the obtained hydroxyl group-containing hydrocarbon, 88.2 parts of polyethylene glycol (Mw: 4,000), 3.7 parts of HDI, and 2.2 parts of bisphenol A diglycidyl ether were reacted at 80° C. for 3 hours to obtain 100 parts of an epoxy group-containing reactive surfactant (D-2) having an average Mw of polyoxyethylene chain of 5,500, an oxyethylene unit content of 80 wt %, an Mw of 30,000, a number of carbon atoms of a hydrocarbon group in a hydrophobic moiety of 31, and an HLB of 18.0.

### Production Example 3

Friedel-Crafts reaction was carried out in the same manner as in the Production Example 1 to obtain a hydroxyl group-containing hydrocarbon [an EO adduct of an addition reaction product of 7 moles of styrene and 1 mole of phenol (EO content: 45%), Mw: 1,700], and 16.9 parts of the obtained hydroxyl group-containing hydrocarbon, 79.7 parts of polyethylene glycol (Mw: 4,000), and 3.4 parts of HDI were reacted at 80° C. for 3 hours to obtain 100 parts of a hydroxyl group-containing reactive surfactant (D-3) having an average Mw of polyoxyethylene chain of 3,600, an oxyethylene unit content of 87 wt %, an Mw of 24,000, a number of carbon atoms of a hydrocarbon group in a hydrophobic moiety of 62, and an HLB of 17.2.

### Production Example 4

A reaction vessel equipped with a stirrer, a dropping funnel, a nitrogen gas-introducing tube, a thermometer, and a reflux condenser was prepared, and 53 parts of 4-α-cumylphenol and 23 parts of a Lewis acid catalyst (manufactured by Mizusawa Industrial Chemicals, Ltd. under the trade name of “Galleon Earth”) were placed in the reaction vessel. The air in the reaction system was replaced with nitrogen gas under stirring, and the materials contained in the reaction vessel were heated to 90° C. At the same temperature, 181 parts of styrene was dropped into the reaction vessel in 3 hours, and then the materials contained in the reaction vessel were reacted at the same temperature for 5 hours. The reaction mixture was cooled to 30° C., and then the catalyst was separated by filtration to obtain 220 parts of an addition reaction product of 7 moles of styrene and 1 mole of 4-α-cumylphenol (Mw: 900). Then, 0.1 part of sodium hydroxide was added thereto, and a temperature was increased to 180° C. Then, 150 moles of ethylene oxide (hereinafter, abbreviated as “EO”) was added to the addition reaction product to obtain 100 parts of a blocked isocyanate group-containing reactive surfactant (D-4) having an average Mw of polyoxyethylene chain of 6,600, an oxyethylene unit content of 88 wt %, an Mw of 7,500, a number of carbon atoms of a hydrocarbon group in a hydrophobic moiety of 71, and an HLB of 17.2.

### Production Examples 5 to 9

Ion-exchanged water, a surfactant (D), and ammonium persulfate were placed in a pressure-resistant reaction vessel, and then the air in the reaction vessel was replaced with nitrogen. The reaction vessel was sealed, and the materials contained therein were stirred and heated to 80° C. Then, 200 parts of a monomer mixture obtained by mixing monomers in a ratio (weight ratio) shown in Table 1 was dropped into the reaction vessel in 2 hours. The thus obtained reaction mixture was aged for 2 hours at the same temperature to obtain a resin particle dispersion (AL-5 to AL-9). The compositional ratio (weight ratio) of components of each of the resin particle dispersions and a volume-average particle diameter (reference value) are shown in Table 1. The volume-average particle diameter of resin particles (A) contained in each of the resin particle aqueous dispersions (AL-5 to AL-9) can be measured by a dynamic light scattering method using a dynamic light scattering particle size analyzer (DLS-7000 manufactured by Otsuka Electronics Co., Ltd.; a sample was prepared by diluting the resin particle aqueous dispersion 400-fold with ion-exchanged water).

TABLE 1

| | | Production | Production | Production | Production | Production |
|---|---|---|---|---|---|---|
| | | Example 5 | Example 6 | Example 7 | Example 8 | Example 9 |
| Resin particle dispersion | | AL-5 | AL-6 | AL-7 | AL-8 | AL-9 |
| Monomers | Styrene | 50 | 40 | 50 | 50 | 40 |
| | Methyl methacrylate | 50 | 50 | 50 | 50 | 50 |
| | Hydroxyethyl methacrylate | 60 | 60 | 0 | 60 | 60 |
| | Butyl acrylate | 40 | 40 | 40 | 40 | 40 |
| | Glycidyl methacrylate | 0 | 0 | 60 | 0 | 0 |
| | Divinylbenzene | 0 | 10 | 0 | 0 | 10 |
| Surfactant (D) | Sodium dodecyl sulfate | 50 | 0 | 50 | 10 | 50 |
| | D-1 | 0 | 50 | 0 | 0 | 0 |

| | | | | | |
|---|---|---|---|---|---|
| Ammonium persulfate | 10 | 10 | 10 | 10 | 10 |
| Ion-exchanged water | 740 | 740 | 740 | 780 | 740 |
| Volume-average particle diameter (μm) | 0.05 | 0.06 | 0.05 | 1 | 0.06 |
| (Reference value) | | | | | |

### Production Example 10

795 parts of ion-exchanged water and 5 parts of sodium dodecyl sulfate were mixed together and stirred well to obtain a mixed solution. To the mixed solution, another mixed solution obtained by mixing 263 parts of ARUFON UG-4070 (which is an epoxy group-containing acrylic polymer manufactured by TOAGOSEI Co., Ltd.) and 87 parts of ARUFON UC-3920 (which is a carboxylic acid-containing acrylic polymer manufactured by TOAGOSEI Co., Ltd.) was added. The thus obtained mixture was stirred using TK Homomixer (manufactured by Tokushu Kika Kogyo Co., Ltd.) at 10,000 rpm for 2 minutes, and was then transferred into a pressure-resistant reaction vessel. The mixture was heated to 40° C. at normal pressures to remove a solvent to obtain a resin particle dispersion (BL-10).

### Production Example 11

795 parts of ion-exchanged water and 5 parts of sodium dodecyl sulfate were mixed together and stirred well to obtain a mixed solution. To the mixed solution, another mixed solution obtained by mixing 235 parts of Desmophene A575X (which is a hydroxyl group-containing acrylic polymer manufactured by Sumitomo Bayer Urethane Co., Ltd.), 112 parts of DURANATE TPA-B-80E (which is isocyanurate-type blocked HDI manufactured by Asahi Kasei Corporation), and 3 parts of dibutyltin laurate was added. The thus obtained mixture was stirred using TK Homomixer (manufactured by Tokushu Kika Kogyo Co., Ltd.) at 10,000 rpm for 2 minutes, and was then transferred into a pressure-resistant reaction vessel. The mixture was heated to 40° C. at normal pressures to remove a solvent to obtain a resin particle dispersion (BL-11).

### Examples 1 to 5 and 7 and Comparative Examples 1 and 2

Ion-exchanged water, any one of the resin particle (A) dispersions produced in the Production Examples 5 to 9, and any one of the surfactants (D) produced in the Production Examples 1 to 4 were mixed in a mixing ratio shown in Table 2 or 3, and they were well stirred. To the thus obtained mixture, a mixed solution of a resin (b), a curing agent (E), and ethyl acetate (in the case of Example 5, a solution obtained by heating a resin (b) and a curing agent (E) to 80° C. and well mixing them) was added, and the thus obtained mixture was stirred using TK Homomixer (manufactured by Tokushu Kika Kogyo Co., Ltd.) at 25° C. (Examples 1 to 4 and 7 and Comparative Examples 1 and 2) or 80° C. (Example 5) at 10,000 rpm (Example 1), 12,000 rpm (Example 2 and Comparative Example 2), 6,500 rpm (Example 3), 8,000 rpm (Example 4), or 4,000 rpm (Comparative Example 1), respectively, for 2 minutes. Then, each of the mixtures obtained in Examples 1 to 4 and 7 and Comparative Examples 1 and 2 was transferred into a pressure-resistant reaction vessel, and was then heated to 40° C. under a reduced pressure to remove a solvent. Each of the thus obtained resin particle dispersions was mixed with a rheology control agent, and they were well stirred to obtain an aqueous dispersion slurry coating materials containing resin particles (A) and resin particles (B), namely, CL-1 to CL-5 and CL-7 (Examples 1 to 5 and 7) and aqueous dispersion slurry coating materials HL-1 and HL-2 (Comparative Examples 1 and 2) were obtained. The solid content of each of the aqueous dispersion slurry coating materials (CL-1 to CL-5 and CL-7 and HL-1 and HL-2) was about 35%. As the resin (b), Desmophene A575X (which is a hydroxyl group-containing acrylic polymer manufactured by Sumitomo Bayer Urethane Co., Ltd.) or ARUFONE UG-4010 (which is an epoxy group-containing acrylic polymer manufactured by TOAGOSEI Co., Ltd.) was used. As the curing agent (E), DURANATE TPA-B80E (which is isocyanurate-type blocked HDI manufactured by Asahi Kasei Corporation) or ARUFONE UC-3910 (which is a carboxylic acid-containing acrylic polymer manufactured by TOAGOSEI Co., Ltd.) was used. As the curing catalyst, dibutyltin laurate was used. As the rheology control agent, Acrysol RM-8W (which is a urethane-modified association-type rheology control agent manufactured by Rohm and Haas) or Boncoat 3750-E (which is an alkali-soluble high-molecular rheology control agent manufactured by DAINIPPON INK AND CHEMICALS, INCORPORATED) was used.

### Example 6

In a vessel (I) equipped with a stirrer, ion-exchanged water, the resin particle (A) dispersion produced in the Production Example 5, and the surfactant (D) produced in the Production Example 4 were mixed in a mixing ratio shown in Table 3, and were then well stirred. In another vessel (II) equipped with a stirrer, a resin (b), a curing agent (E), and ethyl acetate were mixed and well stirred. Then, 640 parts per hour of the mixture contained in the vessel (I) and 450 parts per hour of the mixture contained in the vessel (II) were fed into TK Pipeline Homomixer (manufactured by Tokushu Kika Kogyo Co., Ltd.) using transfer pumps to continuously stir them at 10,000 rpm for 1 hour for dispersion. The thus obtained dispersion was transferred into a pressure-resistant reaction vessel, and was then heated to 40° C. at normal pressures to remove a solvent. The thus obtained resin particle dispersion was mixed with a rheology control agent, and they were well stirred to obtain an aqueous dispersion slurry coating material (CL-6) containing resin particles (A) and resin particles (B). The solid content of the aqueous dispersion slurry coating material (CL-6) was about 35%. As the resin (b), Desmophene A575X (which is a hydroxyl group-containing acrylic polymer manufactured by Sumitomo Bayer Urethane Co., Ltd.) was used. As the curing agent (E), DURANATE TPA-B80E (which is isocyanurate-type blocked HDI manufactured by Asahi Kasei Corporation) was used. As the curing catalyst, dibutyltin laurate was used. As the rheology control agent, Acrysol RM-8W (which is a urethane-modified association-type rheology control agent manufactured by Rohm and Haas) was used.

TABLE 2

| | | Example 1 | Example 2 | Example 3 | Example 4 | Example 5 |
|---|---|---|---|---|---|---|
| Aqueous dispersion slurry coating material | | CL-1 | CL-2 | CL-3 | CL-4 | CL-5 |
| Number of rotations (rpm) of TK Homomixer during | | 10000 | 12000 | 6500 | 8000 | 8000 |
| dispersion of resin (b) | | | | | | |
| Resin (b) | Desmophene A575X | 235 | 235 | — | 235 | 235 |
| | ARUFONE UG-4010 | — | — | 263 | — | — |
| Curing agent (E) | DURANATE TPA-B80E | 112 | 112 | — | 112 | 112 |
| | ARUFONE UC-3910 | — | — | 87 | — | — |
| Curing catalyst | Dibutyltin dilaurate | 3 | 3 | — | 3 | 3 |
| Solvent | Ethyl acetate | 100 | 100 | 100 | 100 | — |
| Resin particle (A) | AL-5 | 100 | — | — | — | — |
| dispersion | AL-6 | — | 100 | — | — | 100 |
| | AL-7 | — | — | 100 | — | — |
| | AL-8 | — | — | — | 100 | — |
| | AL-9 | — | — | — | — | — |
| Surfactant (D) | D-1 | 5 | — | — | — | — |
| | D-2 | — | — | 5 | — | — |
| | D-3 | — | 5 | — | — | 5 |
| | D-4 | — | — | — | — | — |
| | Sodium dodecy sulfate | — | — | — | 5 | — |
| Rheology control | Acrysol RM-8W | 10 | 10 | 10 | 0 | 0 |
| agent | Boncoat 3750-E | 0 | 0 | 0 | 9 | 9 |
| Aqueous dispersion | Ion-exchanged water | 535 | 535 | 535 | 535 | 535 |
| medium (F) | | | | | | |
| Neutralizer | Dimethylaminoethanol | 0 | 0 | 0 | 1 | 1 |

TABLE 3

| | | | | Comparative | Comparative |
|---|---|---|---|---|---|
| | | Example 6 | Example 7 | Example 1 | Example 2 |
| Aqueous dispersion slurry coating material | | CL-6 | CL-7 | HL-1 | HL-2 |
| Number of rotations (rpm) of TK Homomixer during | | 10000 | 12000 | 4000 | 12000 |
| dispersion of resin (b) | | | | | |
| Resin (b) | Desmophene A575X | 235 | 235 | 235 | 235 |
| | ARUFONE UG-4010 | — | — | — | — |
| Curing agent (E) | DURANATE TPA-B80E | 112 | 112 | 112 | 112 |
| | ARUFONE UC-3910 | — | — | — | — |
| Curing catalyst | Dibutyltin dilaurate | 3 | 3 | 3 | 3 |
| Solvent | Ethyl acetate | 100 | 100 | 100 | 100 |
| Resin particle (A) | AL-5 | 100 | — | 100 | — |
| dispersion | AL-6 | — | — | — | — |
| | AL-7 | — | — | — | — |
| | AL-8 | — | — | — | 100 |
| | AL-9 | — | 100 | — | — |
| Surfactant (D) | D-1 | — | — | 5 | 5 |
| | D-2 | — | — | — | — |
| | D-3 | — | 5 | — | — |
| | D-4 | 5 | — | — | — |
| | Sodium dodecy sulfate | — | — | — | — |
| Rheology control | Acrysol RM-8W | 10 | 10 | 10 | 10 |
| agent | Boncoat 3750-E | 0 | 0 | 0 | 9 |
| Aqueous dispersion | Ion-exchanged water | 535 | 535 | 535 | 535 |
| medium (F) | | | | | |
| Neutralizer | Dimethylaminoethanol | 0 | 0 | 0 | 1 |

### Comparative Example 3

990 parts of the resin particle dispersion (BL-10) was mixed with 10 parts of Acrysol RM-8W (which is a urethane-modified association-type rheology control agent manufactured by Rohm and Haas), and they were well stirred to obtain an aqueous dispersion slurry coating material (HL-3) which do not contain resin particles (A).

### Comparative Example 4

990 parts of the resin particle dispersion (BL-11) was mixed with 10 parts of Acrysol RM-8W (which is a urethane-modified association-type rheology control agent manufactured by Rohm and Haas), and they were well stirred to obtain an aqueous dispersion slurry coating material (HL-4) which do not contain resin particles (A).

<Preparation of Plate Coated with Aqueous Dispersion Slurry Coating Material>

An epoxy resin-based cationic electrodeposition coating material was applied (20 μm) onto a zinc phosphate-treated cold-rolled steel plate having a thickness of 0.8 mm, and was then thermally cured at 170° C. for 30 minutes. Then, an automotive black intermediate coating material was further air-sprayed (30 μm) thereon, and was then thermally cured at 140° C. for 30 minutes to obtain a test plate. Each of the aqueous dispersion slurry coating materials of the Examples 1 to 7 and the Comparative Examples 1 to 4 was applied onto the test plate by the use of a commercially available air-spray gun so that an obtained wet coating film had a thickness of 40 to 60 μm, and then the coating film was baked at 190° C. for 20 minutes to obtain a coated plate.

The performance of the aqueous dispersion slurry coating materials and the coated plates were evaluated by the following evaluation methods (1) to (3). The evaluation results are shown in Table 4.

TABLE 4

| Aqueous dispersion slurry coating | | Example 1 | Example 2 | Example 3 | Example 4 | Example 5 | Example 6 |
|---|---|---|---|---|---|---|---|
| material | | CL-1 | CL-2 | CL-3 | CL-4 | CL-5 | CL-6 |
| Evaluation | Volume-average | 0.05 | 0.06 | 0.05 | 1 | 0.06 | 0.05 |
| of slurry | particle diameter (μm) | | | | | | |
| coating | of resin particles (A) | | | | | | |
| material | (Value A) | | | | | | |
| | Volume-average | 2 | 1 | 10 | 5 | 1 | 2 |
| | particle diameter (μm) | | | | | | |
| | of resin particles | | | | | | |
| | contained in aqueous | | | | | | |
| | dispersion slurry | | | | | | |
| | coating material (Value | | | | | | |
| | B) | | | | | | |
| | Value A/Value B | 0.03 | 0.06 | 0.005 | 0.2 | 0.06 | 0.03 |
| | Blocking resistance | ∘ | ∘ | ∘ | ∘ | ∘ | ∘ |
| | Storage stability (μm) | 10≧ | 10≧ | 10≧ | 10≧ | 10≧ | 10≧ |
| Evaluation | Surface smoothness | 13 | 11 | 18 | 16 | 11 | 13 |
| of coating | | | | | | | |
| film | | | | | | | |

| | | | Comparative | Comparative | Comparative | Comparative |
|---|---|---|---|---|---|---|
| Aqueous dispersion slurry coating | | Example 7 | Example 1 | Example 2 | Example 3 | Example 4 |
| material | | CL-7 | HL-1 | HL-2 | HL-3 | HL-4 |
| Evaluation | Volume-average | 0.06 | 0.05 | 1 | — | — |
| of slurry | particle diameter (μm) | | | | | |
| coating | of resin particles (A) | | | | | |
| material | (Value A) | | | | | |
| | Volume-average | 1 | 50 | 1 | 2 | 2 |
| | particle diameter (μm) | | | | | |
| | of resin particles | | | | | |
| | contained in aqueous | | | | | |
| | dispersion slurry | | | | | |
| | coating material (Value | | | | | |
| | B) | | | | | |
| | Value A/Value B | 0.06 | 0.001 | 1 | — | — |
| | Blocking resistance | ∘ | x | x | x | x |
| | Storage stability (μm) | 10≧ | 100≦ | 60 | 80 | 70 |
| Evaluation | Surface smoothness | 11 | 32 | 21 | 28 | 12 |
| of coating | | | | | | |
| film | | | | | | |

### [Evaluation Method]

(1) Volume-Average Particle Diameter and Particle Size Ratio (Evaluation of Aqueous Dispersion Slurry Coating Material)

The volume-average particle diameter of resin particles (A) contained in each of the aqueous dispersion slurry coating materials (CL-1 to CL-7 and HL-1 and HL-2) was measured by dynamic light scattering using a dynamic light scattering particle size analyzer (DLS-7000 manufactured by Otsuka Electronics Co., Ltd.; a sample was prepared by centrifuging the aqueous dispersion slurry coating material and diluting the thus obtained supernatant 400-fold with ion-exchanged water). The volume-average particle diameter of resin particles contained in each of the aqueous dispersion slurry coating materials (CL-1 to CL-7 and HL-1 to HL-4) was measured using a flow-type particle image analyzer (FPIA-2100 manufactured by Sysmex Corporation; a sample was prepared by diluting the aqueous dispersion slurry coating material 400-fold with ion-exchanged water). From the thus measured volume-average particle diameters, the value of [volume-average particle diameter of resin particles (A) (in Table, referred to as “value A”)]/[volume-average particle diameter of resin particles (B) contained in aqueous dispersion slurry coating material (in Table, referred to as “value B”)] was calculated.

(2) Blocking Resistance (Evaluation of Aqueous Dispersion Slurry Coating Material)

20 g of the aqueous dispersion slurry coating material was placed in a cylindrical glass container having a height of 20 cm and a diameter of 3 cm, and was left standing in an incubator maintained at 40° C. for 1 week. Then, the aqueous dispersion slurry coating material was visually observed to check to see whether blocking of particles occurred or not, and was evaluated according to the following criteria.

o: A precipitate was easily redispersed by shaking the container.

x: A precipitate was not redispersed even by shaking the container.

(3) Storage Stability (Evaluation of Aqueous Dispersion Slurry Coating Material)

The aqueous dispersion slurry coating material was stored at room temperature for 1 month after preparation, and then the maximum diameter of aggregated particles (≧10 μm) was measured using a grind gage (which is a grind meter (0 to 100 μm) having two grooves, manufactured by T. P Giken). From the viewpoint of the smoothness of an obtained coating film, the maximum diameter is preferably 10 μm or less.

(4) Surface Smoothness (Evaluation of Coating Film)

The coating film was measured using WAVE SCAN PLUS (manufactured by BYK Gardner), and the surface smoothness of the coating film was evaluated based on a center-line average roughness Lw. A smaller Lw means that the coating film has higher surface smoothness.

### INDUSTRIAL APPLICABILITY

The aqueous dispersion slurry coating material according to the present invention can be widely used for coating of vehicles [e.g., automobiles (e.g., bodies, bumpers, wipers, wheels, sunroofs, door grips, roof racks, crane exteriors, and forklift exteriors), two-wheel vehicles (e.g., brake levers and baskets), and trains (e.g., drainage systems of the Shinkansen (bullet trains), rail joints, bolts, spring washers for the subway)], civil engineering and construction materials [e.g., exteriors (e.g., fences, gates, balconies, handrails, store rooms, terraces, and curtain walls), structural objects (e.g., pre-fab steel frames, shutters, interior and exterior panels, and doors), and others (e.g., rain gutter supports and tiles)], road materials [e.g., protective barriers (e.g., guardrails, guard pipes, guard fences, bridge balustrades, and net fences), road signs, poles (e.g., for traffic signs, curved mirrors, traffic lights, and ads), and tunnel interior panels], telecommunication devices {e.g., household electrical appliances [e.g., microwave ovens, electric pots, and air conditioners (e.g., indoor unit parts and outdoor unit exteriors), dehumidifiers, refrigerators, washing machines, bath heaters, drying machines, freezing showcases, kitchen hoods, and built-in kitchen units], heavy electrical machinery (e.g., panel boards, switchboards, motors, power generators, and electrical components), and others (e.g., electric bulbs, antennas, mercury lamps, telephones, lighting fixtures, and automatic dispenser exteriors)}, water and gas supply systems (e.g., steel pipes, gas water heaters, solar water heaters, and panel tanks), metallic products [e.g., containers (e.g., bottles, drums, containers, and brewing tanks), steel furniture (e.g., desks, top panels for desks, and lockers), and others (e.g., interior parts)], measuring instruments (e.g., electric power meters, flowmeters, and gas meters), safety devices (e.g., fire extinguishers and fire extinguishing equipment), agricultural materials (e.g., tractors, agricultural machines, and nursery cabinets), boats and ships (e.g., water screws, radars, and outboard motors), and sports and leisure goods (e.g., skis and helmets).

1. An aqueous dispersion slurry coating material comprising:
an aqueous medium (F); and contained therein,
resin particles (A) comprising a first resin (a); and
resin particles (B) comprising a second resin (b), and further comprising a rheology control agent,
wherein the value of [volume-average particle diameter of resin particles (A)]/[volume-average particle diameter of resin particles (B)] is in the range of 0.003 to 0.3.

2. The aqueous dispersion slurry coating material according to claim 1, wherein the volume-average particle diameter of the resin particles (A) is in the range of 0.001 to 3 μm and the volume-average particle diameter of the resin particles (B) is in the range of 0.3 to 10 μm.

3. The aqueous dispersion slurry coating material according to claim 1, wherein the glass transition temperature of the resin (a) is in the range of 0 to 100° C. and the glass transition temperature of the resin (b) is in the range of −50 to 50° C.

4. The aqueous dispersion slurry coating material according to claim 1, wherein the resin (a) and/or the resin (b) have/has a reactive functional group.

5. The aqueous dispersion slurry coating material according to claim 1, wherein the resin (a) and/or the resin (b) are/is of at least one kind selected from the group consisting of polyurethane resins, epoxy resins, vinyl resins, and polyester resins.

6. The aqueous dispersion slurry coating material according to claim 1, wherein the resin (a) is a cross-linked resin.

7. The aqueous dispersion slurry coating material according to claim 1, further comprising a surfactant (D), wherein the surfactant (D) is a reactive surfactant having at least one kind of group selected from the group consisting of a carboxyl group, a hydroxyl group, an amino group, an isocyanate group, a blocked isocyanate group, and an epoxy group.

8. The aqueous dispersion slurry coating material according to claim 1, further comprising a curing agent (E).

9. A method for producing an aqueous dispersion slurry coating material, comprising dispersing a resin (b) or a solution obtained by dissolving the resin (b) in a solvent (y) in an aqueous dispersion (G) containing a surfactant (D) and, dispersed in (G), resin particles (A) comprising a resin (a), and further removing the solvent (y) in a case where the resin (b) has been dissolved in the solvent (y), to form resin particles (B) comprising the resin (b) and at the same time by controlling the number of rotations for stirring during the formation of the resin particles (B) to thereby obtain an aqueous dispersion (X) wherein a value of [volume-average particle diameter of resin particles (A)]/[volume-average particle diameter of resin particles (B)] is in the range of 0.003 to 0.3.

10. The method for producing an aqueous dispersion slurry coating material according to claim 9, wherein the volume-average particle diameter of the resin particles (A) is in the range of 0.001 to 3 μm and the volume-average particle diameter of the resin particles (B) is in the range of 0.3 to 10 μm.

11. The method for producing an aqueous dispersion slurry coating material according to claim 9, wherein the resin (a) and/or the resin (b) have/has a reactive functional group.

12. The method for producing an aqueous dispersion slurry coating material according to claim 9, wherein the resin (a) and/or the resin (b) are/is of at least one kind selected from the group consisting of polyurethane resins, epoxy resins, vinyl resins, and polyester resins.

13. The method for producing an aqueous dispersion slurry coating material according to claim 9, wherein the resin (a) is a cross-linked resin.

14. The method for producing an aqueous dispersion slurry coating material according to claim 9, wherein the surfactant (D) is a reactive surfactant having at least one kind of group selected from the group consisting of a carboxyl group, a hydroxyl group, an amino group, an isocyanate group, a blocked isocyanate group, and an epoxy group.

15. The method for producing an aqueous dispersion slurry coating material according to claim 9, further comprising adding a curing agent (E).

16. The method for producing an aqueous dispersion slurry coating material according to claim 15, wherein the curing agent (E) has at least one reactive group selected from the group consisting of an isocyanate group, a blocked isocyanate group, a carboxyl group, an acid anhydride, an amino group, a blocked amino group, a hydroxyl group, a hydrolyzable silyl group, and an epoxy group.

17. The method for producing an aqueous dispersion slurry coating material according to claim 15, wherein the curing agent (E) is added to the resin (b) or a solution obtained by dissolving the resin (b) in a solvent (y).

18. The method for producing an aqueous dispersion slurry coating material according to claim 9, wherein the resin (a) is a nonionic resin.

19. An aqueous dispersion slurry coating material obtained by the method according to claim 9.

20. A coating film obtained by applying the aqueous dispersion slurry coating material according to claim 1.

21. A coating film obtained by applying the aqueous dispersion slurry coating material according to claim 19.
